(19) United States
(12) Patent Application Publication
(10) Pub. No.: US 2025/0355978 A1
(43) Pub. Date: Nov. 20, 2025

(54) AUTHENTICATING MULTI-LAYERED OBJECTS USING ENCODED SIGNALS

(71) Applicant: Digimarc Corporation, Beaverton, OR (US)

(72) Inventors: Jerry Allen McMahan, JR., Oakwood, OH (US); Tony F. Rodriguez, Portland, OR (US); Eric David Evans, Portland, OR (US); Kristyn R. Falkenstern, Portland, OR (US); Mark Tait, Beaverton, OR (US); Tomas Filler, Beaverton, OR (US); Dimitrios Chachlakis, Rochester, NY (US)

(21) Appl. No.: 19/195,334

(22) Filed: Apr. 30, 2025

Related U.S. Application Data
(60) Provisional application No. 63/640,860, filed on Apr. 30, 2024.
(60) Provisional application No. 63/655,488, filed on Jun. 3, 2024.
(60) Provisional application No. 63/682,736, filed on Aug. 13, 2024.
(60) Provisional application No. 63/693,703, filed on Sep. 11, 2024.
(60) Provisional application No. 63/696,787, filed on Sep. 19, 2024.
(60) Provisional application No. 63/710,577, filed on Oct. 22, 2024.
(60) Provisional application No. 63/749,452, filed on Jan. 24, 2025.
(60) Provisional application No. 63/751,272, filed on Jan. 29, 2025.
(60) Provisional application No. 63/751,255, filed on Jan. 29, 2025.
(60) Provisional application No. 63/787,624, filed on Apr. 11, 2025.

(51) Int. Cl. G06F 21/16

(52) U.S. Cl. CPC G06F 21/16

(57) ABSTRACT

Systems, methods and technology for authenticating multi-layered objects using encoded signals such as digital watermarking. In one implementation, a value document includes a substrate and a removable overlayer, with a security feature comprising a digital watermark signal printed to cover portions of both the substrate and overlayer. The digital watermark signal includes spatially arranged signal elements forming a frame of reference. Tampering is detected by evaluating offset values associated with the signal elements, where misalignment within the frame of reference indicates tampering. In some implementations, the value document includes a first digital watermark on the substrate with synchronization and payload components, a token with a second digital watermark, and a removable sticker with a third digital watermark. Additional security features include split-mark configurations, tamper mark configurations, holographic foils with overprinted digital watermarks, and fragile tamper-deterrent features that deform upon tampering attempts, causing detectable signal distortion. Other combinations are also provided.

### RELATED APPLICATION DATA

This application claims the benefit of U.S. Provisional Application Nos. 63/787,624, filed Apr. 11, 2025, 63/751,272, filed Jan. 29, 2025, 63/751,255, filed Jan. 29, 2025, 63/749,452, filed Jan. 24, 2025, 63/710,577, filed Oct. 22, 2024, 63/696,787, filed Sep. 19, 2024, 63/693,703, filed Sep. 11, 2024, 63/682,736, filed Aug. 13, 2024, 63/655,488, filed Jun. 3, 2024, and 63/640,860, filed Apr. 30, 2024, which are each hereby incorporated herein by reference in its entirety.

### TECHNICAL FIELD

This disclosure relates generally to advanced image signal processing involving signal encoding. One application of such technology is authenticating value documents such as lottery tickets and identification documents.

### BACKGROUND AND SUMMARY

One form of signal encoding is digital watermarking. For purposes of this disclosure, the terms “digital watermark,” “watermark,” “data encoding” and “data hiding” are used interchangeably. We sometimes use the terms “encoding,” “encode,” “embedding,” “embed,” and “data hiding” to mean modulating (or transforming) data or physical surfaces to include information therein. For example, data encoding embeds an information signal (e.g., a plural bit payload or a modified version of such, e.g., a 2-D error corrected, spread spectrum signal) in a host signal. This can be accomplished, e.g., by modulating a host signal (e.g., image, video or audio) in some fashion to carry the information signal. The modulated signal can then be printed onto a surface or used to guide a relief forming process.

Some of Digimarc Corporation's work in signal encoding, data hiding, and digital watermarking is reflected, e.g., in U.S. Pat. Nos. 6,947,571; 6,912,295; 6,891,959. 6,763,123; 6,718,046; 6,614,914; 6,590,996; 6,408,082; 6,122,403 and 5,862,260, and in published specifications WO 9953428 and WO 0007356 (corresponding to U.S. Pat. Nos. 6,449,377 and 6,345,104). Each of these patent documents is hereby incorporated by reference herein in its entirety. Other digital watermarking technology is discussed below.

One aspect of the disclosure is an image processing method for authenticating value documents using encoded signals. The method includes obtaining an image depicting a value document, in which the value document comprises a substrate and a removable overlayer, and in which the value document includes a security feature comprising a digital watermark signal printed so as to cover a portion of the substrate and a portion of the removable overlayer, and in which the digital watermark signal comprises a plurality of signal elements spatially arranged to form a frame of reference relative to one another or relative to at least one of the signal elements; determining an offset value associated with each of the plurality of signal elements, said determining an offset value yielding a plurality of offset values; and determining that the value document has been tampered with based on a plurality of offset values.

In one example, the value document is a lottery ticket. In another example, the value document is an identification document or gift card. In some embodiments, the digital watermark signal comprises a synchronization component and an encoded payload. This facilitates determining the offset using the synchronization component.

Determining that the above value document has been tampered with based on a plurality of offset values can be achieved by determining that at least some of the plurality of offset values are misaligned within the frame of reference. In one example, misalignment occurs as a result of a removal and reapplication of the overlayer. Tampering can also be a result of a removal and reapplication of the overlayer.

Another aspect of the disclosure is a value document comprising: a substrate; a removable overlayer adhered to the substrate; and a security feature. The security feature includes a digital watermark signal printed so as to cover a portion of the substrate and a portion of the removable overlayer. The digital watermark signal includes a plurality of signal elements spatially arranged to form a frame of reference relative to one another or relative to at least one of the signal elements. Tampering of the value document can be determined by evaluating the digital watermark signal to obtain a plurality of offset values, whereby tampering is indicated when there is a misalignment of at least some of the offset values within the frame of reference.

Yet another aspect of the disclosure is a value document comprising: a substrate comprising a first digital watermark signal printed or engraved so as to cover a portion of the substrate, in which the first digital watermark signal comprises a synchronization signal comprising plurality of signal elements spatially arranged to form a frame of reference, the first digital watermark signal further comprising a first plural bit payload; a token printed or engraved on the substrate, the token comprising a second digital watermarking signal comprising a second plural bit payload; a removable sticker adhered to the substrate so as to cover the token, in which the removable sticker comprises a third digital watermark signal printed or engraved thereon. Tampering of the value document is determined by evaluating the first digital watermark signal and the third digital watermark signal to obtain a plurality of offset values, whereby tampering is indicated when there is a misalignment of at least some of the offset values within the frame of reference.

In some implementations, the value document includes a loadable credit card or gift card. In one example, third digital watermark signal only comprises an encoded payload. In another example, the plurality of offset values is determined using the synchronization signal. In still another example, misalignment occurs as a result of a removal from and reapplication of the overlayer to the substrate. In some cases, the first plural bit payload is useable to activate the value document. In other cases, the second plural bit payload is useable as a personal identification number to facilitate transactions after value document activation.

Another aspect of the disclosure is a non-transitory computer-readable medium storing instructions that, when executed by one or more processors of a computer system, cause the computer system to perform operations comprising: analyze imagery depicting a value document to determine a frame of reference formed with digital watermarking signals, the value document comprising: i) a substrate comprising a first digital watermark signal printed or engraved so as to cover a portion of the substrate, in which the first digital watermark signal comprises a synchronization signal comprising plurality of signal elements spatially arranged to form the frame of reference, the first digital watermark signal further comprising a first plural bit payload, ii) a token printed or engraved on the substrate, the token comprising a second digital watermarking signal comprising a second plural bit payload, iii) a removable sticker adhered to the substrate so as to cover the token, in which the removable sticker comprises a third digital watermark signal printed or engraved thereon; and determine tampering of the value document by evaluating the first digital watermark signal and the third digital watermark signal to obtain a plurality of offset values, whereby tampering is indicated when there is a misalignment of at least some of the offset values within the frame of reference or when the first plural bit payload is undetectable.

Still another aspect of the disclosure is a method for creating a tamper-evident feature for product authentication. The method comprises: generating a payload comprising encoded product information; applying robustness encoding to the payload to produce a set of encoded message components; mapping the encoded message components to locations on different product parts, comprising at least mapping a first subset of encoded message components to a first product component and mapping a second subset of encoded message components to a second product component different from said first product component; adapting robustness of the encoded message components differently across the different product parts by selectively modifying robustness characteristics of the encoded message components based on respective locations, wherein adapting robustness comprises varying levels of robustness encoding applied to each subset of encoded message components; assessing robustness tolerances of the encoded message components by determining message detection scores; and iteratively adjusting the robustness of the encoded message components until optimal tolerances are achieved.

Yet another aspect includes a tamper evident transaction card, including: first and second product components; encoded message components distributed across the first and second product components, wherein the encoded message components are generated by: generating a payload comprising encoded product information; applying robustness encoding to the payload; mapping the encoded message components to locations on the first and second product components; adapting robustness of the encoded message components differently across the first and second product components by selectively modifying robustness characteristics based on their respective locations; and iteratively adjusting the robustness of the encoded message components until a predetermined tolerance is achieved; wherein each subset of encoded message components is made with a selectively adapted robustness level appropriate to its application location to resist environmental degradation while maintaining differential tamper evidence properties; wherein said selectively adapted robustness comprises varying levels of error correction coding applied to each subset of encoded message components based on environmental exposure and tamper risk of its application location; and wherein successful reading of the encoded product information requires contemporaneous scanning of all encoded message components in their original applied positions, such that any tampering involving separation, removal, or repositioning of any product component bearing encoded message components renders the encoded product information unreadable.

Another aspect of the disclosure is a method of adapting robustness of a signal carrier to enable detection of tampering, the method comprising: generating a payload comprising information symbols and error detection symbols; applying robustness encoding to the payload to produce message components; mapping the message components to locations on parts of a product; adapting robustness of the message components within the parts; and outputting a data carrying pattern.

Additional aspects, features, combinations and technology will be readily apparent from the following description with refence to the accompanying drawings.

### BRIEF DESCRIPTION OF THE DRAWINGS

FIG. 1 is a block diagram of a signal encoder for encoding a digital payload signal into an image signal.

FIG. 2 is a block diagram of a compatible signal decoder for extracting the digital payload signal from an image signal.

FIG. 3 is a flow diagram illustrating operations of a signal generator.

FIG. 4 is a diagram illustrating embedding of an auxiliary signal into host image signal.

FIG. 5 is a flow diagram illustrating a method for decoding a payload signal from a host image signal.

FIG. 6 is a flow diagram illustrating operations of a signal generator.

FIGS. 7A-7C show a security feature for a value document.

FIG. 8A depicts a value document including a removable Sticker/Adhesive layer.

FIG. 8B shows an exploded view of layers comprising the value document of FIG. 8A.

FIGS. 9A and 9B show alternative relationships of a security feature including spatially separated message components and synchronization components.

FIGS. 10A-10D show value documents including a circular overlayer, which obscures a Token provided underneath until removed.

FIG. 10E shows a circular overlayer in which a synchronization component is intentionally misaligned relative to a message component.

FIG. 10F shows another arrangement of a value document including a circular overlayer in which a synchronization component is provided to extend beyond the circular overlayer.

FIG. 10G shows a circular overlayer that is scored, cut or otherwise perforated in a spiral pattern.

FIG. 11A shows a circular overlayer having different colors layers for background ink and overprinted digital watermark signal and resulting scans from an RGB scanner vs. red light scanner; FIG. 11B is a graph of reflectance values for the various inks.

FIG. 12A shows a circular overlayer having different colors layers for background ink and overprinted digital watermark signal and resulting scans from an RGB scanner vs. red light scanner; FIG. 12B is a graph of reflectance values for the various inks.

FIG. 13A shows a circular overlayer having different colors layers for a background ink and two or more overprinted digital watermark signals and resulting scans from an RGB scanner vs. red light scanner; FIG. 13B is a graph of reflectance values for the various inks.

FIGS. 14 and 15 illustrate various holographic foils and digital watermarked images of such holographic images.

FIG. 16-19 illustrates various embodiments of different securely packaged value documents.

FIG. 20 depicts an embodiment of a securely packaged value document, with a bridge layer to mitigate a parallax effect.

FIG. 21 is a flow diagram illustrating a method of adapting the robustness of a signal carrier to enable detection of tampering.

FIG. 22 illustrates a security configuration that combines thermochromic ink with holographic foil to provide robust protection against heat-based tampering attempts.

### DETAILED DESCRIPTION

### Introduction

The following detailed description is divided into three (3) general sections. It should be understood from the outset, however, that we expressly contemplate combining subject matter from one such section with one or more of the other sections. Thus, the sections and section headings are provided for the reader's convenience and are not intended to impose restrictions or limitations. The sections include: I. Signal Encoder and Decoder; II. Authenticating Multi-layered Objects using Encoded Signals; and III. Operating Environments.

### Signal Encoder and Decoder

### Encoder/Decoder

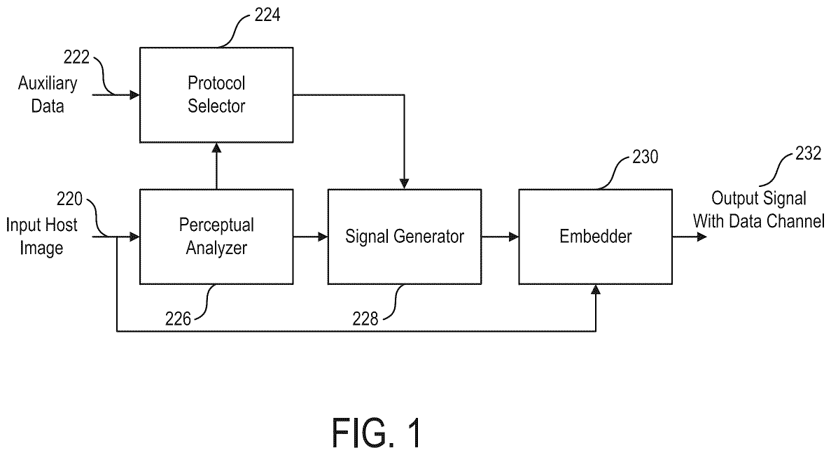

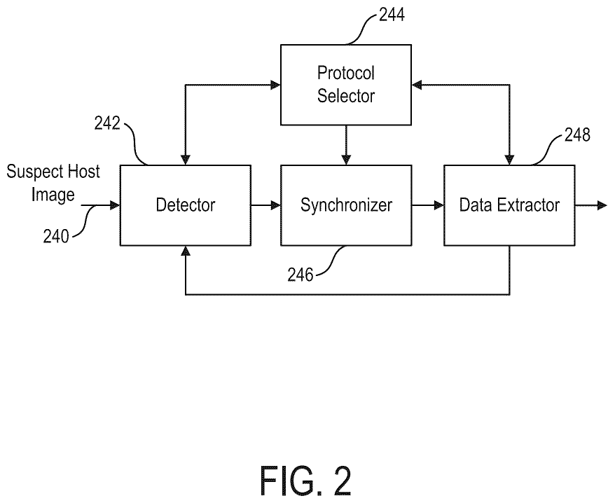

FIG. 1 is a block diagram of a signal encoder for encoding a digital payload signal into an image signal. FIG. 2 is a block diagram of a compatible signal decoder for extracting the digital payload signal from an image signal.

While the signal encoder and decoder may be used for communicating a data channel for many applications, one objective for use in physical objects is robust signal communication through images formed on and captured from these objects. Signal encoders and decoders, like those provided by the Digimarc Corporation, Beaverton, Oregon, USA, communicate auxiliary data in a data carrier within image content. Encoding and decoding is applied digitally, yet the signal survives digital to analog transformation and analog to digital transformation. For example, the encoder generates a modulated digital image that is converted to a rendered form, such as a printed image. The modulated digital image includes the encoded signal prior to rendering. Prior to decoding, a receiving device has or communicates with an imager to capture the modulated signal, convert it to an electric signal, which is digitized and then processed by the FIG. 2 signal decoder.

Inputs to the signal encoder include a host image 220 and auxiliary data payload 222. The objectives of the encoder include encoding a robust signal with desired payload capacity per unit of host signal (e.g., a unit may include the spatial area of a two-dimensional tile within the host signal), while maintaining perceptual quality. In some cases, there may be very little variability or presence of a host signal. In this case, there is little host interference on the one hand, yet little host content in which to mask the presence of the data channel within an image. Some examples include a package design that is devoid of much image variability (e.g., a single, uniform color). See, e.g., U.S. Pat. No. 9,635,378, incorporated herein by reference in its entirety.

The auxiliary data payload 222 includes the variable data information to be conveyed in the data channel, possibly along with other protocol data used to facilitate the communication. The protocol of the auxiliary data encoding scheme comprises the format of the auxiliary data payload, error correction coding schemes, payload modulation methods (such as the carrier signal, spreading sequence, encoded payload scrambling or encryption key), signal structure (including mapping of modulated signal to embedding locations within a tile), error detection in payload (CRC, checksum, etc.), perceptual masking method, host signal insertion function (e.g., how auxiliary data signal is embedded in or otherwise combined with host image signal in a package or label design), and/or synchronization method and signals.

The protocol defines the manner in which the signal is structured and encoded for robustness, perceptual quality and/or data capacity. For a particular application, there may be a single protocol, or more than one protocol, depending on application requirements. Examples of multiple protocols include cases where there are different versions of the channel, different channel types (e.g., several digital watermark layers within a host). Different versions may employ different robustness encoding techniques or different data capacity. Protocol selector module 224 determines the protocol to be used by the encoder for generating a data signal. It may be programmed to employ a particular protocol depending on the input variables, such as user control, application specific parameters, or derivation based on analysis of the host signal.

Perceptual analyzer module 226 analyzes the input host signal to determine parameters for controlling signal generation and embedding, as appropriate. It is not necessary in certain applications, while in others it may be used to select a protocol and/or modify signal generation and embedding operations. For example, when encoding in host color images that will be printed or displayed, the perceptual analyzer 256 is used to ascertain color content and masking capability of the host image. The output of this analysis, along with the rendering method (display or printing device) and rendered output form (e.g., ink and substrate) is used to control auxiliary signal encoding in particular color channels (e.g., one or more channels of process inks, Cyan, Magenta, Yellow, or Black (CMYK) or spot colors), perceptual models, and signal protocols to be used with those channels. Please see, e.g., the visibility and color model technology used in perceptual analysis in U.S. Pat. Nos. 7,352,878, 9,117,268, 9,380,186, 9,401,001 and 9,449,357, which are hereby incorporated by reference in their entirety.

The perceptual analyzer module 226 also computes a perceptual model, as appropriate, to be used in controlling the modulation of a data signal onto a data channel within image content as described below.

The signal encoder may comprise one or more trained network models (e.g., deep learning models utilizing convolutional neural networks (CNNs) and/or recurrent neural networks (RNNs)) to optimize the embedding of a variable watermark payload in the host signal for robustness to attacks and perceptual quality. These trained network models are employed within the signal encoder to produce the modulated host, carrying the auxiliary data. The digital watermarking may occur as the digital asset is generated. For example, a payload can be inserted into a digital asset during artificial intelligence content generation (“Gen AI”). Machine trained encoders are further discussed, e.g., in assignee's U.S. Pat. Nos. 11,704,765 and 11,625,805, and in assignee's US Published application Nos. 20220270199 and 20210357690, each of which is hereby incorporated herein in its entirety.

The signal generator module 228 operates on the auxiliary data and generates a data signal according to the protocol. It may also employ information derived from the host signal, such as that provided by perceptual analyzer module 226, to generate the signal. For example, the selection of data code signal and pattern, the modulation function, and the amount of signal to apply at a given embedding location may be adapted depending on the perceptual analysis, and in particular on the perceptual model and perceptual mask that it generates. Please see below and the incorporated patent documents for additional aspects of this process.

Embedder module 230 takes the data signal and modulates it into an image by combining it with the host image. The operation of combining may be an entirely digital signal processing operation, such as where the data signal modulates the host signal digitally, may be a mixed digital and analog process or may be purely an analog process (e.g., where rendered output images are combined in the analog domain, with some signals being modulated data and others being host image content, such as the various layers of a package design file). As mentioned above, the embedder module (or encoder) may also comprise one or models, such as encoder, decoder, and generative adversarial network models trained using machine learning. The encoder may employ models, such as neural networks (e.g., convolutional neural networks) trained using adversarial machine learning to optimize perceptual quality and watermark robustness. Please see the above incorporated patent documents for additional aspects of this process.

There are a variety of different functions for combining the data and host in digital operations. One approach is to adjust the host signal value as a function of the corresponding data signal value at an embedding location, which is limited or controlled according to the perceptual model and a robustness model for that embedding location. The adjustment may be altering the host image by adding a scaled data signal or multiplying by a scale factor dictated by the data signal value corresponding to the embedding location, with weights or thresholds set on the amount of the adjustment according to the perceptual model, robustness model, and/or available dynamic range. The adjustment may also be altered by setting the modulated host signal to a particular level (e.g., quantization level) or moving it within a range or bin of allowable values that satisfy a perceptual quality or robustness constraint for the encoded data.

As detailed further below, the signal generator 228 produces a data signal with data elements that are mapped to embedding locations in an image tile. These data elements are modulated onto the host image at the embedding locations. A tile may include a pattern of embedding locations. The tile derives its name from the way in which it is repeated in contiguous blocks of a host signal, but it need not be arranged this way. In image-based encoders, we may use tiles in the form of a two-dimensional array (e.g., 128×128, 256×256, 512×512) of embedding locations. The embedding locations correspond to host signal samples at which an encoded signal element is embedded in an embedding domain, such as a spatial domain (e.g., pixels at a spatial resolution), frequency domain (frequency components at a frequency resolution), or some other feature space. We sometimes refer to an embedding location as a bit cell, referring to a unit of data (e.g., an encoded bit or chip element) encoded within a host signal at the location of the cell. Again, please see the documents incorporated herein for more information on variations for particular type of media.

The combining operation may include one or more iterations of adjustments to optimize the modulated host for perceptual quality or robustness constraints. One approach, for example, is to modulate the host image so that it satisfies a perceptual quality metric as determined by perceptual model (e.g., visibility model) for embedding locations across the signal. Another approach is to modulate the host image so that it satisfies a robustness metric across the signal. Yet another is to modulate the host image according to both the robustness metric and perceptual quality metric derived for each embedding location. The incorporated documents provide examples of these techniques. Below, we highlight a few examples. See, e.g., U.S. Pat. No. 9,449,357; and see also, U.S. Pat. Nos. 9,401,001 and 9,565,335, which are each hereby incorporated by reference in its entirety.

For color images, the perceptual analyzer generates a perceptual model that evaluates visibility of an adjustment to the host by the embedder and sets levels of controls to govern the adjustment (e.g., levels of adjustment per color direction, and per masking region). This may include evaluating the visibility of adjustments of the color at an embedding location (e.g., units of noticeable perceptual difference in color direction in terms of CIE Lab values), Contrast Sensitivity Function (CSF), spatial masking model (e.g., using techniques described by Watson in US Published Patent Application No. US 2006-0165311 A1, which is incorporated by reference herein in its entirety), etc. One way to approach the constraints per embedding location is to combine the data with the host at embedding locations and then analyze the difference between the encoded host with the original. The perceptual model then specifies whether an adjustment is noticeable based on the difference between a visibility threshold function computed for an embedding location and the change due to embedding at that location. The embedder then can change or limit the amount of adjustment per embedding location to satisfy the visibility threshold function. Of course, there are various ways to compute adjustments that satisfy a visibility threshold, with different sequence of operations. See, e.g., U.S. Pat. Nos. 7,352,878, 9,117,268, 9,380,186, 9,401,001 and 9,449,357, US A1, already incorporated herein.

The Embedder also computes a robustness model. The computing of a robustness model may include computing a detection metric for an embedding location or region of locations. The approach is to model how well the decoder will be able to recover the data signal at the location or region. This may include applying one or more decode operations and measurements of the decoded signal to determine how strong or reliable the extracted signal. Reliability and strength may be measured by comparing the extracted signal with the known data signal. Below, we detail several decode operations that are candidates for detection metrics within the embedder. One example is an extraction filter which exploits a differential relationship to recover the data signal in the presence of noise and host signal interference. At this stage of encoding, the host interference is derivable by applying an extraction filter to the modulated host. The extraction filter models data signal extraction from the modulated host and assesses whether the differential relationship needed to extract the data signal reliably is maintained. If not, the modulation of the host is adjusted so that it is.

Detection metrics may be evaluated such as by measuring signal strength as a measure of correlation between the modulated host and variable or fixed data components in regions of the host or measuring strength as a measure of correlation between output of an extraction filter and variable or fixed data components. Depending on the strength measure at a location or region, the embedder changes the amount and location of host signal alteration to improve the correlation measure. These changes may be particularly tailored so as to establish relationships of the data signal within a particular tile, region in a tile or bit cell pattern of the modulated host. To do so, the embedder adjusts bit cells that violate the relationship so that the relationship needed to encode a bit (or M-ary symbol) value is satisfied and the thresholds for perceptibility are satisfied. Where robustness constraints are dominant, the embedder will exceed the perceptibility threshold where necessary to satisfy a desired robustness threshold.

The robustness model may also model distortion expected to be incurred by the modulated host, apply the distortion to the modulated host, and repeat the above process of measuring detection metrics and adjusting the amount of alterations so that the data signal will withstand the distortion. See, e.g., U.S. Pat. Nos. 9,380,186, 9,401,001 and 9,449,357 for image related processing.

This modulated host is then output as an output image signal 232, with a data channel encoded in it. The operation of combining also may occur in the analog realm where the data signal is transformed to a rendered form, such as a layer of ink or coating applied by a commercial press to substrate. Another example is a data signal that is overprinted as a layer of material, engraved in, or etched onto a substrate, where it may be mixed with other signals applied to the substrate by similar or other marking methods. In these cases, the embedder employs a predictive model of distortion and host signal interference and adjusts the data signal strength so that it will be recovered more reliably. The predictive modeling can be executed by a classifier that classifies types of noise sources or classes of host image and adapts signal strength and configuration of the data pattern to be more reliable to the classes of noise sources and host image signals that the encoded data signal is likely to be encounter or be combined with.

The signal output 232 from the Embedder typically incurs various forms of distortion through its distribution or use. For printed objects, this distortion occurs through rendering an image with the encoded signal in the printing process, and subsequent scanning back to a digital image via a camera or like image sensor.

Turning to FIG. 2, the signal decoder receives an encoded host signal 240 and operates on it with one or more processing stages to detect a data signal, synchronize it, and extract data.

The decoder is paired with an input device in which a sensor captures an analog form of the signal and an analog to digital converter converts it to a digital form for digital signal processing. Though aspects of the decoder may be implemented as analog components, e.g., such as preprocessing filters that seek to isolate or amplify the data channel relative to noise, much of the decoder is implemented as digital signal processing modules that implement the signal processing operations within a scanner. As noted, these modules can be implemented as software instructions executed within an image scanner or camera, an FPGA, or ASIC, etc.

The detector 242 is a signal processing module that detects presence of the data channel. The incoming signal is referred to as a suspect host because it may not have a data channel or may be so distorted as to render the data channel undetectable. The detector is in communication with a protocol selector 244 to get the protocols it uses to detect the data channel. It may be configured to detect multiple protocols, either by detecting a protocol in the suspect signal and/or inferring the protocol based on attributes of the host signal or other sensed context information. A portion of the data signal may have the purpose of indicating the protocol of another portion of the data signal. As such, the detector is shown as providing a protocol indicator signal back to the protocol selector 244.

The synchronizer module 246 synchronizes the incoming signal to enable data extraction. Synchronizing includes, for example, determining the distortion to the host signal and compensating for it. This process provides the location and arrangement of encoded data elements within the host signal.

The data extractor module 248 gets this location and arrangement and the corresponding protocol and demodulates a data signal from the host. The location and arrangement provide the locations of encoded data elements. The extractor obtains estimates of the encoded data elements and performs a series of signal decoding operations.

As detailed in examples below and in the incorporated documents, the detector, synchronizer and data extractor may share common operations, and in some cases may be combined. For example, the detector and synchronizer may be combined, as initial detection of a portion of the data signal used for synchronization indicates presence of a candidate data signal, and determination of the synchronization of that candidate data signal provides synchronization parameters that enable the data extractor to apply extraction filters at the correct orientation, scale and start location of a tile. Similarly, data extraction filters used within data extractor may also be used to detect portions of the data signal within the detector or synchronizer modules. The decoder architecture may be designed with a data flow in which common operations are re-used iteratively, or may be organized in separate stages in pipelined digital logic circuits so that the host data flows efficiently through the pipeline of digital signal operations with minimal need to move partially processed versions of the host data to and from a shared memory unit, such as a RAM memory.

The decoder (or detector) may alternatively comprise one or more trained network models (e.g., deep learning models utilizing convolutional neural networks (CNNs) and/or recurrent neural networks (RNNs)) to optimize the detection of a variable watermark payload in a host signal. These trained network models are employed within the signal detector to yield auxiliary data, despite the presence of noise, rotation, scaling, temporal shifts, scaling, etc. Machine trained decoders are further discussed, e.g., in assignee's U.S. Pat. Nos. 11,704,765 and 11,625,805, and in assignee's US Published application Nos. 20220270199 and 20210357690, each of which is hereby incorporated herein in its entirety.

### Signal Generator

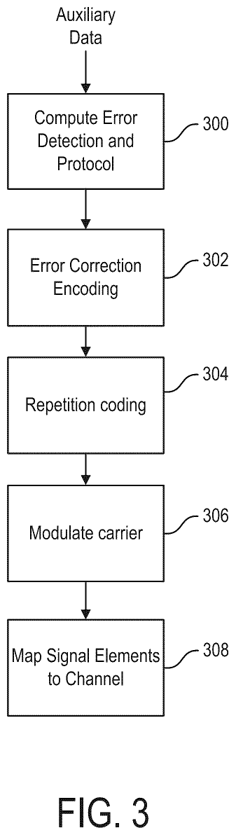

FIG. 3 is a flow diagram illustrating operations of a signal generator. Each of the blocks in the diagram depict processing modules that transform the input auxiliary data into a digital payload data signal structure. The input auxiliary data may include, e.g., a Global Trade Item Number (GTIN) developed by GS1. For example, the GTIN may be structured in the GTIN-12 format for UPC codes. Of course, the input auxiliary data may represent other plural bit codes as well. For a given protocol, each block provides one or more processing stage options selected according to the protocol. In processing module 300, the auxiliary data payload is processed to compute error detection bits, e.g., such as a Cyclic Redundancy Check (CRC), Parity, check sum or like error detection message symbols. Additional fixed and variable messages used in identifying the protocol and facilitating detection, such as synchronization signals may be added at this stage or subsequent stages.

Error correction encoding module 302 transforms the message symbols of the digital payload signal into an array of encoded message elements (e.g., binary or M-ary elements) using an error correction method. Examples include block codes, BCH, Reed Solomon, convolutional codes, turbo codes, etc.

Repetition encoding module 304 repeats and concatenates the string of symbols from the prior stage to improve robustness. For example, certain message symbols may be repeated at the same or different rates by mapping them to multiple locations within a unit area of the data channel (e.g., one unit area being a tile of bit cells, as described further below).

Repetition encoding may be removed and replaced entirely with error correction coding. For example, rather than applying convolutional encoding (1/3 rate) followed by repetition (repeating three times), these two can be replaced by convolution encoding to produce a coded payload with approximately the same length.

Next, carrier modulation module 306 takes message elements of the previous stage and modulates them onto corresponding carrier signals. For example, a carrier might be an array of pseudorandom signal elements, with equal number of positive and negative elements (e.g., 16, 32, 64 elements), or another waveform, such as sine wave or orthogonal array. In the case of positive and negative elements, the payload signal is a form of binary antipodal signal. It also may be formed into a ternary (of 3 levels, −1, 0, 1) or M-ary signal (of M levels). These carrier signals may be mapped to spatial domain locations or spatial frequency domain locations. Another example of carrier signals are sine waves, which are modulated using a modulation scheme like phase shifting, phase quantization, and/or on/off keying. In one embodiment, carrier modulation module XORs each bit of a scrambled signature with a string of 16 binary elements (a “spreading key”), yielding 16 “chips” having “0” and “1” values. If error correction encoding yields a signature of 1024 bits (which can then be randomized), then the carrier modulation module 306 produces 16,384 output chips.

Mapping module 308 maps signal elements of each modulated carrier signal to locations within the channel. In the case where a digital host signal is provided, the locations correspond to embedding locations within the host signal. The embedding locations may be in one or more coordinate system domains in which the host signal is represented within a memory of the signal encoder. The locations may correspond to regions in a spatial domain, temporal domain, frequency domain, or some other transform domain. Stated another way, the locations may correspond to a vector of host signal features, which are modulated to encode a data signal within the features.

Mapping module 308 also maps a synchronization signal to embedding locations within the host signal, for embodiments employing an explicit synchronization signal. An explicit synchronization signal is described further below.

To accurately recover the payload, the decoder extracts estimates of the coded bits at the embedding locations within each tile. This requires the decoder to synchronize the image under analysis to determine the embedding locations. For images, where the embedding locations are arranged in two dimensional blocks within a tile, the synchronizer determines rotation, scale and translation (origin) of each tile. This may also involve approximating the geometric distortion of the tile by an affine transformation that maps the embedded signal back to its original embedding locations.

In some cases, the output of carrier modulation module 306 and/or mapping module 308 is used to generate a watermark signal that can be concatenated or combined with a host image or audio in a trained convolutional neural network (CNN) or recurrent neural networks (RNN) encoder model. These concatenated or combined host image or audio can be used as training input to such models. Different loss functions and optimization strategies can be employed during the training phase to achieve a desired performance, e.g., desired robustness against attacks (scaling, rotation, translation, cropping, etc.).

To facilitate synchronization, the auxiliary signal may include an explicit or implicit synchronization signal. An explicit synchronization signal is an auxiliary signal separate from the encoded payload that is embedded with the encoded payload, e.g., within the same tile). An implicit synchronization signal is a signal formed with the encoded payload, giving it structure that facilitates geometric/temporal synchronization. Examples of explicit and implicit synchronization signals are provided in U.S. Pat. Nos. 6,614,914, and 5,862,260, which are each hereby incorporated herein by reference in their entirety.

In particular, one example of an explicit synchronization signal is a signal comprised of a set of sine waves, with pseudo-random phase, which appear as peaks in the Fourier domain of the suspect signal. See, e.g., U.S. Pat. Nos. 6,614,914, and 5,862,260, describing use of a synchronization signal in conjunction with a robust data signal. Also see U.S. Pat. No. 7,986,807, which is hereby incorporated by reference in its entirety.

U.S. Pat. No. 9,182,778, which is hereby incorporated by reference in its entirety, provides additional methods for detecting an embedded signal with this type of structure and recovering rotation, scale and translation from these methods.

Examples of implicit synchronization signals, and their use, are provided in U.S. Pat. Nos. 5,862,260, 6,614,914, 6,625,297, 7,072,490, 9,747,656, which are hereby incorporated by reference in its entirety.

Signal encoders and decoders may also employ network models trained to embed and extract the auxiliary data signal so as to be robust to geometric and temporal transformations, and thus, provide implicit synchronization. In these machine-learning based approaches, portions of the auxiliary data may function as a synchronization signal. Further, the features or encoding domains in which the models are trained to embed and extract the auxiliary data may be selected to be robust to anticipated forms of geometric or temporal transformation (e.g., spatial or temporal scale, rotation, or shift invariant feature sets).

### Signal Embedding in Host

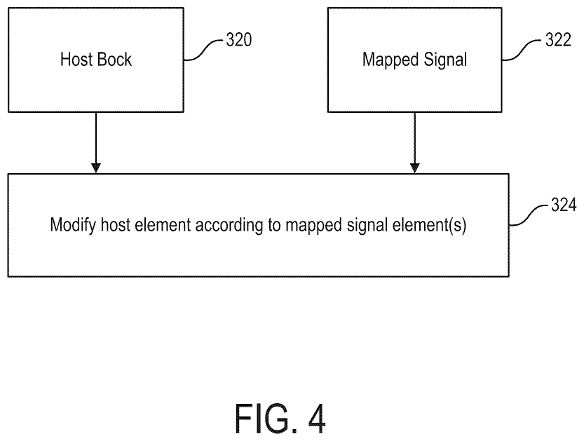

FIG. 4 is a diagram illustrating embedding of an auxiliary signal into host signal. As shown, the inputs are a host signal block (e.g., blocks of a host digital image) (320) and an encoded auxiliary signal (322), which is to be inserted into the signal block. The encoded auxiliary signal may include an explicit synchronization component, or the encoded payload may be formulated to provide an implicit synchronization signal. Processing block 324 is a routine of software instructions or equivalent digital logic configured to insert the mapped signal(s) into the host by adjusting the corresponding host signal sample(s) at an embedding location according to the value of the mapped signal element. For example, the mapped signal is added/subtracted from corresponding a sample value, with scale factor and threshold from the perceptual model or like mask controlling the adjustment amplitude. In implementations with an explicit synchronization signal, the encoded payload and synchronization signals may be combined and then added or added separately with separate mask coefficients to control the signal amplitude independently.

Following the construction of the payload, error correction coding is applied to the binary sequence. This implementation applies a convolutional coder at rate 1/4, which produces an encoded payload signal of 4096 bits. Each of these bits is modulated onto a binary antipodal, pseudorandom carrier sequence (−1, 1) of length 16, e.g., by executing an instruction or circuit to multiply or XOR the payload bit with the binary equivalent of chip elements in its carrier to yield 4096 modulated carriers, for a signal comprising 65,536 elements. These elements map to the 65,536 embedding locations in each of the 256 by 256 tiles.

An alternative embodiment, for robust encoding on packaging employs tiles of 128 by 128 embedding locations. Through convolutional coding of an input payload at rate 1/3 and subsequent repetition coding, an encoded payload of 1024 bits is generated. Each of these bits is modulated onto a similar carrier sequence of length 16, and the resulting 16,384 signal elements are mapped to the 16,384 embedding locations within the 128 by 128 tile.

There are several alternatives for mapping functions to map the encoded payload to embedding locations. In one, these elements have a pseudorandom mapping to the embedding locations. In another, they are mapped to bit cell patterns of differentially encoded bit cells as described in U.S. patent application Ser. No. 14/724,729 (issued as U.S. Pat. No. 7,747,656). In the latter, the tile size may be increased to accommodate the differential encoding of each encoded bit in a pattern of differential encoded bit cells, where the bit cells corresponding to embedding locations at a target resolution (e.g., 300 DPI).

U.S. Pat. No. 9,635,378 describes methods for inserting auxiliary signals in areas of package and label designs that have little host image variability. These methods are particularly useful for labels, including price change labels and fresh food labels. These signal encoding methods may be ported to the printing sub-system in scales used within fresh food, deli and meat departments to encode GTINs and control flags for variable weight items in the image of a label, which is then printed by the printer sub-system (typically a thermal printer) on the label and affixed to an item.

For an explicit synchronization signal, the mapping function maps a discrete digital image of the synchronization signal to the host image block. For example, where the synchronization signal comprises a set of Fourier magnitude peaks or sinusoids with pseudorandom phase, the synchronization signal is generated in the spatial domain in a block size coextensive with the 256 by 256 tile (or other tile size, e.g., 128 by 128) at target embedding resolution.

Various detailed examples of encoding protocols and processing stages of these protocols are provided in U.S. Pat. Nos. 6,614,914, 5,862,260, and 6,674,876, which are hereby incorporated by reference, and U.S. Pat. Nos. 9,117,268 and 9,635,378, previously incorporated. More background on signaling protocols, and schemes for managing compatibility among protocols, are provided in U.S. Pat. No. 7,412,072, which is hereby incorporated by reference.

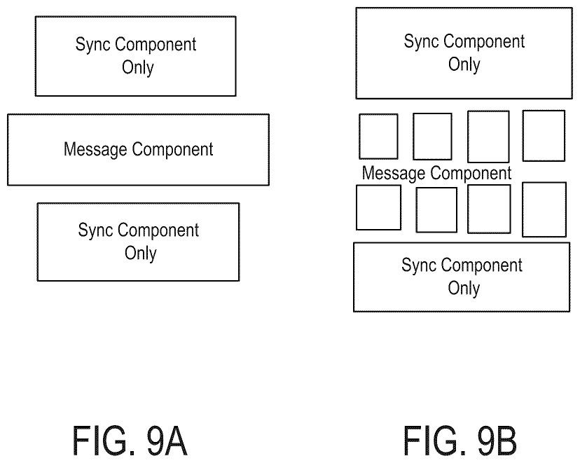

One signaling approach, which is detailed in U.S. Pat. Nos. 6,614,914, and 5,862,260, is to map elements to pseudo-random locations within a channel defined by a domain of a host signal. See, e.g., FIG. 9 of U.S. Pat. No. 6,614,914. In particular, elements of a watermark signal are assigned to pseudo-random embedding locations within an arrangement of sub-blocks within a block (referred to as a “tile”). The elements of this watermark signal correspond to error correction coded bits. These bits are modulated onto a pseudo-random carrier to produce watermark signal elements (block 306 of FIG. 3), which in turn, are assigned to the pseudorandom embedding locations within the sub-blocks (block 308 of FIG. 3). An embedder module modulates this signal onto a host signal by increasing or decreasing host signal values at these locations for each error correction coded bit according to the values of the corresponding elements of the modulated carrier signal for that bit.

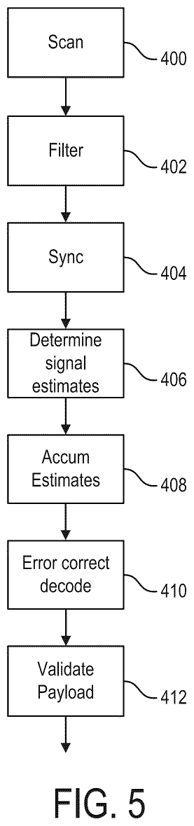

FIG. 5 is a flow diagram illustrating a method for decoding a payload signal from a host image signal. The frames are captured at a resolution preferably near the resolution at which the auxiliary signal has been encoded within the original image (e.g., 300 DPI, 100 DPI, etc.). An image up-sampling or down-sampling operation may be performed to convert the image frames supplied by the imager to a target resolution for further decoding.

The resulting image blocks supplied to the decoder from these frames may potentially include an image with the payload. At least some number of tiles of encoded signal may be captured within the field of view, if an object with encoded data is being scanned. Otherwise, no encoded tiles will be present. The objective, therefore, is to determine as efficiently as possible whether encoded tiles are present.

In the initial processing of the decoding method, it is advantageous to select frames and blocks within frames that have image content that are most likely to contain the encoded payload. From the image passed to the decoder, the decoder selects image blocks for further analysis. The block size of these blocks is set large enough to span substantially all a complete tile of encoded payload signal, and preferably a cluster of neighboring tiles. However, because the distance from the camera may vary, the spatial scale of the encoded signal is likely to vary from its scale at the time of encoding. This spatial scale distortion is further addressed in the synchronization process.

For more on block selection, please see U.S. Pat. No. 9,521,291, which is hereby incorporated by reference.

Please also see U.S. Pat. No. 9,922,220, which is hereby incorporated by reference, for more on block selection where processing time is more limited.

The first stage of the decoding process filters the image to prepare it for detection and synchronization of the encoded signal (402). The decoding process sub-divides the image into blocks and selects blocks for further decoding operations. For color images, a first filtering stage converts the input color image signal (e.g., RGB values) to a color channel or channels where the auxiliary signal has been encoded. See, e.g., U.S. Pat. No. 9,117,268, which is hereby incorporated herein by reference in its entirety, for more on color channel encoding and decoding. For an image captured under red illumination by a monochrome scanner, the decoding process operates on this “red” channel sensed by the scanner. Some scanners may pulse LEDs of different color to obtain plural color or spectral samples per pixel as described in U.S. Pat. No. 9,749,607, which is hereby incorporated by reference.

A second filtering operation isolates the auxiliary signal from the host image. Pre-filtering is adapted for the auxiliary signal encoding format, including the type of synchronization employed. For example, where an explicit synchronization signal is used, pre-filtering is adapted to isolate the explicit synchronization signal for the synchronization process.

In some embodiments, the synchronization signal is a collection of peaks in the Fourier domain. Prior to conversion to the Fourier domain, the image blocks are pre-filtered. See, e.g., LaPlacian pre-filter in U.S. Pat. No. 6,614,914. A window function is applied to the blocks and then a transform to the Fourier domain, applying an FFT. Another filtering operation is performed in the Fourier domain. See, e.g., pre-filtering options in U.S. Pat. Nos. 6,988,202, 6,614,914, and 9,182,778, which are hereby incorporated by reference in their entirety.

For more on filters, also see U.S. Pat. No. 7,076,082, which is hereby incorporated by reference in its entirety. This patent describes a multi-axis filter, e.g., an oct-axis filter. Oct axis compares a discrete image sample with eight neighbors to provide a compare value (e.g., +1 for positive difference, −1 or negative difference), and sums the compare values. Different arrangements of neighbors and weights may be applied to shape the filter according to different functions. Another filter variant is a cross shaped filter, in which a sample of interest is compared with an average of horizontal neighbors and vertical neighbors, which are then similarly summed.

Next, synchronization process (404) is executed on a filtered block to recover the rotation, spatial scale, and translation of the encoded signal tiles. This process may employ a log polar method as detailed in U.S. Pat. No. 6,614,914 or least squares approach of U.S. Pat. No. 9,182,778, to recover rotation and scale of a synchronization signal comprised of peaks in the Fourier domain. To recover translation, the phase correlation method of U.S. Pat. No. 6,614,914 is used, or phase estimation and phase deviation methods of U.S. Pat. No. 9,182,778 are used.

Alternative methods perform synchronization on an implicit synchronization signal, e.g., as detailed in U.S. Pat. No. 9,747,656.

Next, the decoder steps through the embedding locations in a tile, extracting bit estimates from each location (406). This process applies, for each location, the rotation, scale and translation parameters, to extract a bit estimate from each embedding location (406). As it visits each embedding location in a tile, it transforms it to a location in the received image based on the affine transform parameters derived in the synchronization and then samples around each location. It does this process for the embedding location and its neighbors to feed inputs to an extraction filter (e.g., oct-axis or cross shaped). A bit estimate is extracted at each embedding location using filtering operations, e.g., oct axis or cross shaped filter (see above), to compare a sample at embedding locations with neighbors. The output (e.g., 1, −1) of each compare operation is summed to provide an estimate for an embedding location. Each bit estimate at an embedding location corresponds to an element of a modulated carrier signal.

The signal decoder estimates a value of each error correction encoded bit by accumulating the bit estimates from the embedding locations of the carrier signal for that bit (408). For instance, in the encoder embodiment above, error correction encoded bits are modulated over a corresponding carrier signal with 16 elements (e.g., multiplied by or XOR with a binary anti-podal signal). A bit value is demodulated from the estimates extracted from the corresponding embedding locations of these elements. This demodulation operation multiplies the estimate by the carrier signal sign and adds the result. This demodulation provides a soft estimate for each error correction encoded bit.

These soft estimates are input to an error correction decoder to produce the payload signal (410). For a convolutional encoded payload, a Viterbi decoder is used to produce the payload signal, including the checksum or CRC. For other forms of error correction, a compatible decoder is applied to reconstruct the payload. Examples include block codes, BCH, Reed Solomon, Turbo codes.

Next, the payload is validated by computing the check sum and comparing with the decoded checksum bits (412). The check sum matches the one in the encoder, of course. For the example above, the decoder computes a CRC for a portion of the payload and compares it with the CRC portion in the payload.

At this stage, the payload is stored in shared memory of the decoder process. The recognition unit in which the decoder process resides returns it to the controller via its interface. This may be accomplished by various communication schemes, such as IPC, shared memory within a process, DMA, etc.

Technology for so-called “sparse” mark encoding (e.g., encoding with variable density to adapt for visual quality and reliability) is described in, e.g., Digimarc's US Published Patent Application Nos. US 2016-0275639 A1, US 2019-0171856 A1, and US 2019-0332840 A1, and PCT international patent application no. PCT/US19/19410, filed Feb. 25, 2019 (published as WO 2019/165364), each of which is hereby incorporated herein by reference in its entirety. A sparse mark may include a pattern of spatial locations where ink is deposited or not (or where an area is engraved or not). For example, a sparse signal may be comprised of ink dots on a light background, such that the signal forms a pattern of subtly darker spatial locations. The signal is designed to be sparse by the spacing apart of the darker locations on the light background. Conversely, the signal may be designed as an array of lighter “holes” on a relatively darker background. In still other cases, the signal may include a pattern of both darker and lighter signal elements.

### II. Authenticating Multi-Layered Objects Using Encoded Signals

This Section II describes authenticating multi-layered objects using encoded signals, e.g., such as those signals discussed above in Section I, and as further described below.

### Further Encoding

Initially, let us drill down into some further encoding details.

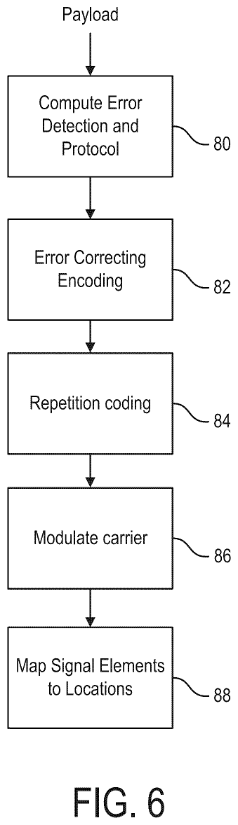

FIG. 6 is a flow diagram illustrating operations of an example signal generator. This signal generator may be used to generate raw data signal tiles. Each of the blocks in the diagram depict processing modules that transform the input payload data into a data signal structure. For a given data signal protocol, each block provides one or more processing stage options selected according to the protocol. In processing module 80, the data payload is processed to compute error detection bits, e.g., such as a Cyclic Redundancy Check, Parity, check sum or like error detection message symbols. Additional fixed and variable messages used in identifying the protocol and facilitating detection, such as synchronization signals may be added at this stage or subsequent stages.

Error correction encoding module 82 transforms the message symbols into an array of encoded message elements (e.g., binary or M-ary elements) using an error correction method. Examples include block codes, BCH, Reed Solomon, convolutional codes, turbo codes, etc.

Repetition encoding module 84 repeats the string of symbols from the prior stage to improve robustness. Repetition encoding may be removed and replaced entirely with error correction coding. For example, rather than applying convolutional encoding (e.g., at 1/3 rate) followed by repetition (repeating three times), these two can be replaced by convolution encoding to produce a coded payload with approximately the same length.

Next, carrier modulation module 86 takes message elements of the previous stage and modulates them onto corresponding carrier signals. For example, a carrier might be an array of pseudorandom signal elements, with equal number of positive and negative elements (e.g., 16, 32, 64 elements), or another waveform. In the case of positive and negative elements, the payload signal is in the form of a binary antipodal signal. It also may be formed into a ternary (of 3 levels, −1, 0, 1) or M-ary signal (of M levels).

Mapping module 88 maps signal elements of each modulated carrier signal to locations. These may be spatial locations with a tile. They may also be spatial frequency locations. In this case, the signal elements are used to modulate frequency domain values (such as magnitude or phase). The resulting frequency domain values are inverse transformed into the spatial domain to create a raw data signal tile in the spatial domain.

Mapping module 88 also maps a synchronization signal to locations. These locations may overlap or not the locations of the payload. The encoded payload and synchronization signal are signal components that are weighted and together, form the raw data signal of a tile. Unless specifically noted otherwise, we use the term “raw data signal” to include both an encoded payload and a synchronization signal, perhaps in a weighted or prioritized fashion.

To accurately recover the payload, a reader extracts estimates of the coded data signal at their locations within a tile. This requires the reader to synchronize the image under analysis to determine the tile locations, and signal element locations within the tiles (we sometimes refer to these signal elements as “waxels”). The locations are arranged in two dimensional blocks forming each tile. The synchronizer determines rotation, scale and translation (origin) of each tile and/or one or more waxels within the tile.

The raw data signal tile comprises an explicit and/or implicit synchronization signal. An explicit synchronization signal is a signal component separate from the encoded payload that is included with the encoded payload, e.g., within the same tile. An implicit synchronization signal is a signal formed with the encoded payload, giving it structure that facilitates geometric synchronization. Examples of explicit and implicit synchronization signals are provided in our U.S. Pat. Nos. 6,614,914, and 5,862,260.

In particular, one example of an explicit synchronization signal is a signal comprised of a set of sine waves, with pseudo-random phase, which appear as peaks in the Fourier domain of the suspect signal. See, e.g., U.S. Pat. Nos. 6,614,914, and 5,862,260, describing use of a synchronization signal in conjunction with a robust data signal. Also see U.S. Pat. No. 7,986,807, which is hereby incorporated by reference.

### Authenticating Multi-Layered Objects Using Encoded Signals

The following description addresses several critical technical problems for value document security. Traditional security features for value documents such as lottery tickets, gift cards, and identification documents have been vulnerable to sophisticated tampering attempts, particularly when a removable overlayer conceals sensitive information (e.g., Personal Identification Number or “PIN”, Card Verification Value or “CVV”, or document activation or authentication information). Conventional approaches often fail to detect when an overlayer has been removed and subsequently reapplied, allowing fraudsters to access the sensitive information or activation codes without detection. The following description solves these problems, e.g., in some embodiments, through a novel implementation of digital watermarking that creates a verifiable spatial or signal relationship between signal elements on the substrate and document layer(s). For example, by establishing a frame of reference through strategically positioned watermark signal elements, aspects of the disclosure enable detection of even slight misalignments that occur when an overlayer is removed and reapplied. Such technical solutions provide tamper evidence that is machine-readable, difficult to circumvent, and can be verified using widely available imaging devices such as smartphone cameras or point-of-sale scanners.

Now consider multi-layered objects. A few multi-layered objects may include value documents, product packaging, and objects including at least one overlayer (e.g., a laminate layer, overprinting, adhesive layer, and/or scratch-off layer, secure packaging, card carrier, etc.). For the purposes of this disclosure, value documents are broadly defined and may include, e.g., lottery tickets, credit cards, bank cards, debit cards, phone cards, passports, driver's licenses, network access cards, employee badges, security cards, visas, immigration documentation, national ID cards, voter registration cards, citizenship cards, social security cards, security badges, certificates, identification cards or documents, police ID cards, border crossing cards, legal instruments or documentation, security clearance badges and cards, firearm permits and concealed carry permits, gift certificates, gift cards, rechargeable (e.g., load money onto) credit and gift cards, labels or product packaging, membership cards or badges, etc., etc. Also, the terms “document,” “card,” and “documentation” are used interchangeably throughout this patent document. Identification documents are also sometimes referred to as “ID documents.”

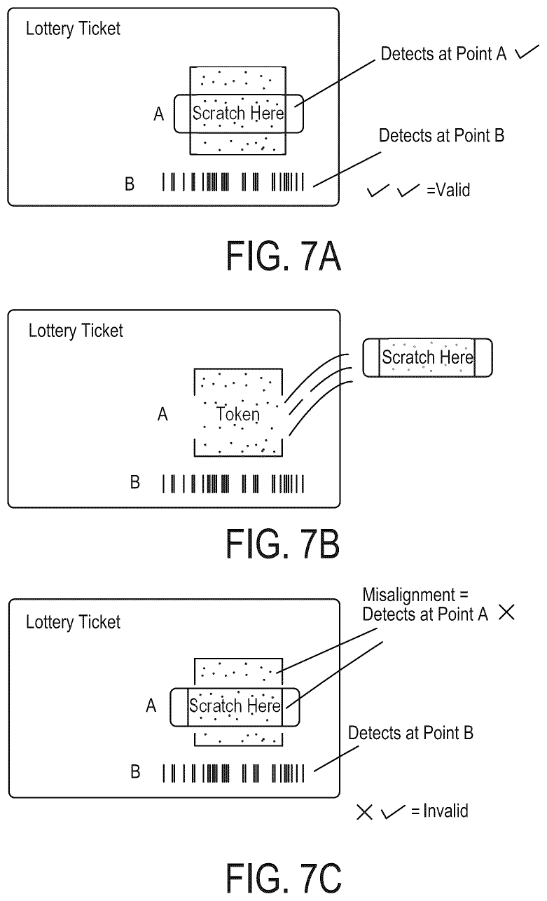

A physical structure of one type of value document includes ink printed on or otherwise provided on portions of a substrate or core layer, with one or more overlayers. An overlayer may include a laminate layer, a film, overprinting (e.g., with an ink, varnish, etc.), a sticker, an adhesive layer, and/or scratch-off material. The overlayer may cover (or overlay) some or all of the substrate or core layer. In one example, consider a lottery ticket (or other value document) as shown in FIGS. 7A-7C. A substrate or core layer receives printing thereon, e.g., a printed barcode or digital watermark (at position B) and a security feature printed within the square area (see FIG. 7B) at position A. Here, in this example, the security feature includes digital watermarking, in particular, a so-called sparse mark pattern. One example of a sparse mark pattern includes dots of ink or varnish collectively covering 30% or less of the pattern area (and more commonly covering 20%, 10%, 5%, or 3% or less of the pattern area). Suitable sparse digital watermarks are detailed, e.g., in our US Published Patent Application No. 20190332840, and in PCT Published Patent Application Nos. WO2016153911 and WO2019165364, which are each hereby incorporated herein by reference in its entirety. The dots can be formed by a dark ink or varnish (e.g., black or blue, which aids with red light image capture), or they may be formed by a light (e.g., whitish or transparent) ink or varnish. In other examples, the digital watermarking need not be sparse. For example, the digital watermarking can be generated, e.g., with one or more trained network models (e.g., deep learning models utilizing convolutional neural networks (CNNs) and/or recurrent neural networks (RNNs).

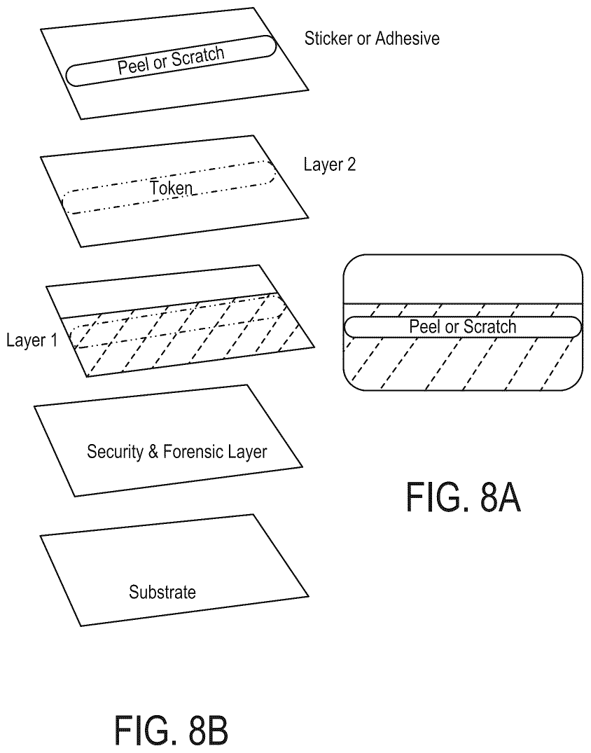

With reference to FIGS. 8A & 8B, the overlayer includes a portion of the security feature that is printed or otherwise provided in alignment with security feature portions located on the substrate (“substrate security feature portions”) within the square area. In one example, a portion of the security feature provided on the overlayer includes one or more components of a sparse digital watermark. For example, the digital watermark signal can be printed or otherwise provided on the value document after the overlayer is adhered (or otherwise attached to) the value document. This ensures alignment between security feature components spatially located on the substrate layer with security feature components spatially located on the overlayer. The overlayer may also cover and obscure a token provided on the substrate or core layer. The token may include printed text, e.g., alpha-numeric numbers, a machine-readable code (e.g., a 1D or 2D barcode, digital watermark signal, data matrix), an activation pin or code, card number, and/or lottery numbers or elements, etc. In one example, the overlayer includes an opaque substance (e.g., a latex or adhesive) printed or flooded over the token, which can be scratched off. In another example, the overlayer includes a sticker that is adhesively attached to the core over the token. In still another example, the overlayer includes a laminate that is heat affixed over the core/token. It should be realized that the dimensions and shape of the overlayer in the FIGS. 7A-7C are for illustrative purposes only. Of course, the overlayer can be larger or smaller relative to the core layer. Additionally, the security feature need not be confined to a square area and may cover more or less of the substrate/core layer and/or overlayer.

As discussed above, digital watermark patterns may include a reference, orientation or synchronization signal. Such signals permit recovery of “waxel” data. The term “waxel” here refers to individual digital watermark signal elements within a tile by which digital watermark data can be conveyed. Waxels can be printed at different resolutions of, e.g., 75 or 150 “waxels per inch” (or “WPI”). A digital watermark synchronization signal enables accurate resolution of printed spatial locations, relative to the watermark pattern, to within less than half of a waxel-sometimes to a tenth of a waxel. At 150 WPI, a half waxel works out to a spatial accuracy of 0.0033 inches (0.085 mm).

In an illustrative embodiment, digital imagery captured and depicting a digital watermark signal is provided to a digital watermark detector, e.g., as discussed above in Section I and in the incorporated by reference patent documents. The digital watermark detector can be housed, e.g., in a smartphone such as an iPhone or Android device. The watermark detector determines scale, rotation, and/or translation with which the depicted digital watermark signal (e.g., on an overlayer and/or substrate) is depicted in the imagery. The scale indicates a correspondence factor between watermark waxels and image pixels. The rotation indicates an angle at which rows of waxels are depicted in the captured imagery, relative to rows of pixels. The translation indicates an offset between a known position in the image data (e.g., the upper left pixel or central pixel) and a known position in the watermark pattern (a so-called watermark “origin,” e.g., the upper left waxel or a central waxel). Translation can be measured in waxels (or pixels) and typically include two components—an x-translation, and an y-translation. These parameters define a waxel frame of reference for each of the waxels in a digital watermark signal (or within a sub-component, e.g., a watermark tile).

The value document in FIG. 7A can be authenticated by verifying the security feature alone or in combination with another verification features (e.g., digital watermark or 1D/2D barcode read). For example, imagery is captured of the value document, e.g., by a camera-equipped smartphone. A digital watermark detector operating on the smartphone detects the signal and uses the synchronization component in the digital watermark signal to evaluate waxels contained therein. For example, scale, rotation, and/or translation values for each waxel is evaluated. The values can be reconciled with one another and/or with threshold values to determine whether they relate to one another or to predetermined values in an expected manner. For example, are the scale and rotation values of the waxels contained in components printed on the substrate as expected (e.g., within a plus or minus percentage to allow for image angle capture) relative to waxels contained in components printed on the overlayer? Alternatively (or additionally), the translation values of the waxels can be evaluated to see if the waxels are located within the frame of reference as expected. For example, are the translation offset values (X and Y locations) for waxels located on the overlayer skewed or offset relative to waxels detected on the substrate layers? If so, this may evidence that the original positioning of those waxels has been altered.

Returning to FIG. 7A, if the waxel alignment values are unaltered, and (optionally) if a digital watermark payload is successfully decoded, the security feature is deemed authentic. An additional level of security is provided by successfully reading another machine-readable code carried by the value document, e.g., by a 1 or 2-D barcode, 2D code, or second digital watermarking signal. The security feature's payload may also be cross correlated with information carried by another machine-readable code. The code and security feature can be related through a cryptographic relationship or carry the same or overlapping information. The value document in FIG. 7A is authentic since the security feature is aligned as expected and (optionally) since a 2nd machine-readable code is verified. (A point-of-sale checkout station can be programmed to yield a familiar audible “beep” upon successful authentication (e.g., based on a digital watermark decode and/or alignment check) and another audible “beep” upon verification or decoding of the 2nd machine-readable code, e.g., a barcode or other digital watermark signal.)

Let's now explore a theft or tampering attempt for the lottery ticket shown in FIGS. 7A-7C. A thief obtains a value document and removes the overlayer by scratching off the layer or by peeling it off (e.g., in the case of a sticker), etc. See FIG. 7B. The thief then has access to the previously hidden token. This may allow the thief to determine if a lottery ticket is a winner, or in the case of a pre-paid card or gift card, access the activation information carried by the token. The thief then reapplies the sticker over the token. FIG. 7C. (In the case of a scratch-off overlayer, the thief applies a new latex or adhesive to the value document.) The likelihood of reapplying a sticker exactly aligned as it was originally printed is slim; particularly if reapplied at a store or retail center or in a car in the parking lot. Moreover, a new layer of adhesive or scratch-off material will lack a corresponding digital watermark signal aligned as expected.

To authenticate the tampered-with value document shown in FIG. 7C, digital imagery depicting the value document is captured, e.g., with a camera-equipped smartphone or tablet. A digital watermark detector analyzes the captured digital imagery to detect the digital watermark signal. Using the digital watermark's synchronization component, the detector evaluates waxels contained within the digital watermark signal. For example, scale, rotation, and translation values for waxels are evaluated. The values can be reconciled with one another and/or with threshold values to determine whether they relate to one another within an expected frame of reference or within predetermined values. For example, in the FIG. 7C example, the translation values of overlayer waxels are offset within the frame of reference relative to translation values of substrate waxels. This waxel misalignment (or offset) indicates tampering. As such, the value document can be flagged as fraudulent, tampered with and/or flagged for human inspection. In this case, even though the digital watermark signal may still be decoded to yield a message payload, the rotation, scale and/or translation values generated from the digital watermark signal components show a misalignment.

The above examples include a security feature (comprising a digital watermark signal having both a synchronization component and a message component) spatially located over the substrate area and on the overlayer area. An alternative embodiment, however, spatially separates these components. For example, only the synchronization component is printed or otherwise provided on the substrate of a value document (e.g., on the top and bottom one-thirds of the square shown in FIG. 7A). The message component is only provided on the overlayer. This configuration splits the digital watermarking signal into different spatial areas (referred to also as a “split mark”). Detection proceeds as discussed above in Section I, e.g., with detection of the synchronization component and then decoding of the message component, except the two components do not spatially overlap. Here again, the digital watermark signal is likely printed once the overlayer is applied over a token on the value document. This ensures alignment between the synchronization signal and the message signal. Misalignment of a removed-and-then-reapplied overlayer may result in a failure to detect the message component due to misalignment. In an event that the message is detected, there should be a detectable signal misalignment as discussed above. (The reverse is also possible, e.g., having the message component provided on the substrate while the synchronization component is provided only on the overlayer.)

In a related implementation, the message component is only provided on the overlayer, and the overlayer is provided such that the message component is surrounded on all sides by the synchronization signal on the substrate. That is, the synchronization signal is printed or aligned so that it is adjacent to the top, bottom, left and right sides of the overlayer. This may provide additional synchronization and tamper evidence. In still another implementation, a message component of the security feature can be provided or printed in an extended manner, e.g., so that it does not line up with one or more borders of the synchronization component. See, e.g., FIG. 9A where horizontal edges of a middle block (e.g., corresponding to a sticker or message component) are wider or longer than a top and bottom block (e.g., corresponding to the substrate or synchronization component). This extension of the message component further complicates realignment of, e.g., a sticker, if removed. For example, there are no clear boundaries as to where the sticker should be aligned if reapplied. (The converse can also be implemented, where the synchronization components are wider relative to the message component.) FIG. 9B shows an implementation where the message component is reduced, e.g., it is only provided in the middle smaller blocks. For example, there are fewer print elements representing the message component relatively to print elements representing the synchronization component. This sparse message component to synchronization component arrangement increases sensitivity to alterations, e.g., misalignment and/or scratch-off attempts. In related implementations, the synchronization component is placed in between the message component locations. This allows for additional synchronization but will still evidence misalignment from tampering and replacing the overlayer or message components.

Now consider additional value document embodiments with reference to FIGS. 8A & 8B. An assembled, multi-layered value document is depicted in FIG. 8A, while the FIG. 8A value document's exploded-view layers are shown in FIG. 8B. This value document includes a peelable (or removable) Sticker and/or a scratchable adhesive layer (“Peel or Scratch”), a peelable Sticker and scratchable adhesive layer are sometimes interchangeable referred to herein as a “removable sticker” or a “removable layer,” a Token hidden under the Sticker/Adhesive layer (Layer 2), one or more digital watermarks carried by Layer 1, an optional security and forensic digital watermarking Layer, and a Substrate or core layer. It should be noted here that the “layers” in some cases can be provided as printed ink and/or varnish layers and not overlaminate or core layers.

Layer 1 comprises an overlayer (provided over the Substrate and/or Security & Forensic Layer) that includes one or more digital watermark encoded signals. Layer 1 can be provided via a laminate layer or by an ink and/or varnish layer. If Layer 1 is provided via ink and/or varnish, such ink and/or varnish need not be printed or flooded over the entire Substrate. The digital watermarking signals can be generated, e.g., with one or more trained network models (e.g., deep learning models utilizing convolutional neural networks (CNNs) and/or recurrent neural networks (RNNs)). Alternatively, the digital watermark encoded signals can be implemented using, e.g., the so-called sparse digital watermarking mentioned above. One example of a sparse mark pattern includes dots or print elements of ink or varnish collectively covering 30% or less of a pattern area (and more commonly covering 20%, 10%, 5%, or 3% or less of the pattern area). Suitable sparse digital watermarks are detailed, e.g., in our US Published patent application No. 20190332840, and in PCT Published Patent Application Nos. WO2016153911 and WO2019165364, which are each hereby incorporated herein by reference in its entirety. The dots can be formed by a dark ink or varnish (e.g., black or blue), or they may be formed by a light (e.g., whitish or transparent) ink or varnish. Other forms of digital watermarking can be used for the one or more digital watermark encoded signals in Layer 1. We refer to this one or more digital watermark encoded signals as digital watermark 1 (or “WM1”). The one or more digital watermark encoded signals preferably include one or more plural-bit payloads. In a first implementation, a first plural-bit payload includes a unique identifier (or “ID1”) for the value document. In a second implementation, the first plural-bit payload includes a pointer to or index (ID1) for a first plural-bit payload for the value document. In the second implementation, the pointer or index (ID1) is used to access a unique identifier, e.g., via a database look up in a database accessed over a network (e.g., an area network, the internet, a cellular network, etc.). In the illustrated embodiment, WM1 is spatially limited to within an area (the dashed lined area) that is less than the entire area of Layer 1 (e.g., limited to ¾ or less of a spatial area of the layer, or ⅔ or less of a spatial area the layer, or ½ or less of a spatial area of the layer, or ⅓ or less of a spatial area of the layer, or ¼ or less of a spatial area of the layer). The dot-dash oval in Layer 1 represents a spatial area where the token (Layer 2) will be spatially located and/or printed and/or flooded within. The dot-dash outline corresponds to the boundary created by the Sticker/Adhesive layer once applied to the value document.

Layer 2 includes a Token that, once the value document is assembled, is obscured by an overlaid Sticker/Adhesive layer. For example, the Sticker is peeled off or the adhesive is scratched off to reveal the Token. Layer 2 can include an overlaminate layer including printing thereon or may include a layer of printed ink (or varnish) or flooded ink (or varnish) over (or under) Layer 1. In some implementations, a mixture of ink and varnish is printed on the overlaminate layer or directly on the Substrate. The dot-dash outline corresponds to the boundary created by the Sticker/Adhesive layer once applied to the value document. The token is preferably conveyed in a machine-readable format, and not in human-readable alphanumeric characters. This format helps prevent causal theft by removing a sticker to plainly see the token and then replacing the sticker after copying the token's alphanumeric characters. Most preferably, the token is carried with digital watermarking. We refer to this Layer 2 digital watermark encoded signal as digital watermark 2 (or “WM2”).

The Sticker/adhesive layer preferably includes one or more components of a digital watermark encoded signal. We refer to this one or more components of a digital watermark encoded signal as digital watermark 3 (or “WM3”). Here again, the digital watermarking signals can be generated, e.g., with one or more trained network models (e.g., deep learning models utilizing convolutional neural networks (CNNs) and/or recurrent neural networks (RNNs)). Alternatively, the digital watermark encoded signals can be implemented using, e.g., the so-called sparse digital watermarking mentioned above. In one example, the adhesive layer includes an opaque substance (e.g., a latex or adhesive) printed or flooded over the Token, which can be scratched off. In another example, the overlayer includes a sticker that is adhesively (and removably) attached to the substrate and/or Layer 2 over the token. In still another example, the overlayer includes a laminate that is heat affixed over the Token/Layer 2/Substrate. It should be realized that the dimensions and shape of the Sticker/Adhesive layer in the FIGS. 9A and 9B are for illustrative purposes only. Of course, such a layer can be larger or smaller relative to the substrate. In one implementation, WM3 and WM1 are printed or otherwise provided on the value document (on the Sticker/Adhesive layer) after the Sticker/Adhesive layer is adhered (or otherwise attached to) the value document. This ensures alignment between WM1 components spatially located on the substrate layer with WM3 components spatially located on the Sticker/Adhesive.

Digital watermarking or other encoded signals can be used to provide security and/or forensic information. Such digital watermarking or other encoded signals can be carried in a Security & Forensic Layer. There is an advantage to using a different signal encoding technique with this layer. For example, reading this digital watermark or other encoded signal may require UV illumination, a different decoding key, a deep learning-based detector, etc. Digital watermarking in this layer (referred to here as “WM4”) can carry manufacturing information, distribution information, etc. Such information allows supply chain monitoring and/or detection of suspected grey goods (e.g., authentic goods that are illegally diverted to a different location or distribution path).

Now consider the interaction of the above layers in activating and detecting tampering with the FIGS. 8A & 8B value document.

Typically, to activate a value document, e.g., in the case of a pre-paid credit or debit card or gift card, a user presents the value document to a checkout station, e.g., self-checkout or clerk-assisted checkout. At this point, it has been heretofore difficult to determine whether the Sticker/Adhesive layer has been removed and replaced. Such prior removal and replacement may indicate that a thief has copied the Token and perhaps a unique value document identifier (which is often carried on the value document in a 1D or 2D barcode, and/or printed or engraved string of alphanumeric characters). This may allow the thief to steal balance value once the value document is activated by going online shopping with the value document identifier/pin once activated.

In a first embodiment, WM1 and WM3 (respectively, on Layer 1 and on the Sticker/Adhesive layer) collectively function as a security feature to detect tampering prior to activation. The security feature may function, e.g., similarly to the security feature discussed above with respect to FIGS. 7A-7C. For example, WM3 includes a portion of the security feature that is printed or otherwise provided in alignment with WM1 within the hashed area on Layer 1. WM1 and WM3 can be printed or otherwise provided on the value document after the Sticker is adhered (or otherwise attached to) the value document. As discussed above, digital watermark patterns may include a reference, orientation or synchronization signal. Such signals permit recovery of “waxel” data.

In an illustrative example, digital imagery captured and depicting a digital watermark signal is provided to a digital watermark detector, e.g., as discussed above in Section I and in the incorporated by reference patent documents. The digital watermark detector can be housed, e.g., in a smartphone such as an iPhone or Android device, or in a checkout terminal including a 2D scanner or camera. The watermark detector determines scale, rotation, and translation with which the depicted digital watermark signals (e.g., on the Sticker and/or Layer 1) is depicted in the imagery. The scale indicates a correspondence factor between watermark waxels and image pixels. The rotation indicates an angle at which rows of waxels are depicted in the captured imagery, relative to rows of pixels. The translation indicates an offset between a known position in the image data (e.g., the upper left pixel or central pixel) and a known position in the watermark pattern (a so-called watermark “origin,” e.g., the upper left waxel or the central waxel). Translation can be measured in waxels (or pixels) and typically include two components—an x-translation, and an y-translation. These parameters define a waxel frame of reference for each of the waxels in a digital watermark signal.

The value document in FIG. 8A can be authenticated by verifying the security feature alone or in combination with a successful digital watermark read of, e.g., ID1. For example, imagery is captured of the value document, e.g., by a camera-equipped smartphone, tablet or camera/scanner equipped point-of-sale checkout station. A digital watermark detector detects a signal and uses the synchronization component to evaluate waxels contained therein. For example, scale, rotation, and translation values for each waxel are evaluated. The values can be reconciled with one another and/or with threshold values to determine whether they relate to one another or to predetermined values in an expected manner. For example, are the scale and rotation values of the waxels contained in WM1 components printed on Layer 1 as expected (e.g., within a plus or minus percentage to allow for image angle capture) relative to waxels contained in WM3 components printed on the Sticker? Alternatively (or additionally), the translation values of the waxels can be evaluated to see if the waxels are located within the frame of reference as expected. For example, are the translation offset values (X and Y locations) for waxels associated with WM3 on the Sticker skewed or offset relative to waxels associated with WM1 detected on the Layer 1? If so, this may evidence that the original positioning of the Sticker WM1 waxels have been altered. If not tampered with, the value document can be activated as discussed below. As mentioned above, validation of the security feature plus successful detection of WM1's ID1 may be combined to verify authenticity.

In a related embodiment, WM3 only includes a message component, and cooperates with a synchronization signal carried by WM1. The WM3 message is printed on the Sticker so as to be aligned with the synchronization signal. If the Sticker is removed and replaced, even carefully so, the message component on the Sticker may be out of sync relative to the WM1 synchronization signal. This may lead to a failure to read the WM1 or WM3 messages or may result in a message detection score below a predetermined threshold. For example, the “message strength” metric described in assignee's U.S. Pat. No. 11,250,534, which is hereby incorporated herein by reference in its entirety, can be used to calculate a message strength. A calculated message strength can be compared to a predetermined threshold to determine whether the value document has been tampered with. (For example, the threshold can be determined by testing authentic value documents to value document that that had their Stickers removed and replaced.)

Returning to value document activation, a user presents a value document to be activated at checkout. The security feature as discussed above is evaluated. If no tampering is detected, the activation process continues. Captured imagery depicting the value document is analyzed to detect and decode ID1 carried by WM1, WM3 or combined WM1 and WM3. If ID1 is not successfully detected, the value document can be deemed defective or potentially tampered with. ID1 includes or points to (e.g., via database lookup) a unique identifier associated with the value document. That unique identifier is associated with a value document account. We use the term “account” broadly here. For example, the account may include a data record associating the unique identifier with an activation status (e.g., yes/no), balance ($), transaction history, personal identification number (“PIN”) and/or activation date. The PIN is often preselected and associated with the unique identifier and carried by the Token printed on the card. The point-of-sale terminal (or smartphone/tablet) completes an activation process (e.g., receives payment, activates card, and updates balance). If the value document includes a mag-stripe, it can be swiped through a mag-stripe encoder at checkout to transfer balance information to the value document's mag-stripe. Otherwise, or additionally, such information is transmitted to the corresponding online account to update information contained therein.

Once activated, a user can remove the Sticker/Adhesive layer to access the Token. In a first implementation, the Token includes a PIN number or other activation code that is required to complete transactions. As discussed above, the Token is preferably carried with a less perceptible symbology, e.g., via digital watermarking WM2 vs. plain view alphanumeric characters. (WM2 watermarking can use, e.g., the technologies discussed above in Section I including deep learning network, sparse signaling or other digital watermarking technologies.) A user launches a digital watermark detector, e.g., on a smartphone or smart device such as an iPhone, iPad, tablet, laptop or Android device. The digital watermark detector detects WM2 and, optionally, presents the PIN to the user via a graphical user interface (GUI) for manual entry when prompted. If the digital watermark detector is built into a retail shopping application (app), the PIN can be automatically communicated to a payment module without displaying it to the user. In other implementations, a user captures imagery of the value document in a first instance to detect and decode WM1. This allows decoding of ID1, which can be linked to the associated online account. The account can be updated to track and update balance, transaction history and offer a comparison with a predetermined PIN to authorize purchases. The user then is prompted through the retail shopping app to scan the value document for the PIN information to authorize a transaction. Instead of two scans, the retail shopping app may be configured to search for both WM1 and WM2 within the same captured imagery.

We note that WM4 need not be printed on the same document side as WM1, WM2 and WM3. Moreover, WM4 maybe co-located on the same layer and spatial area as WM1, WM2 and/or WM3.

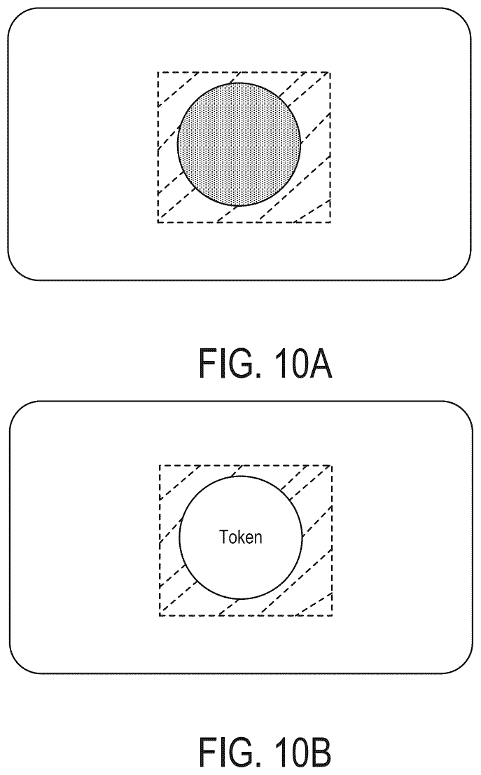

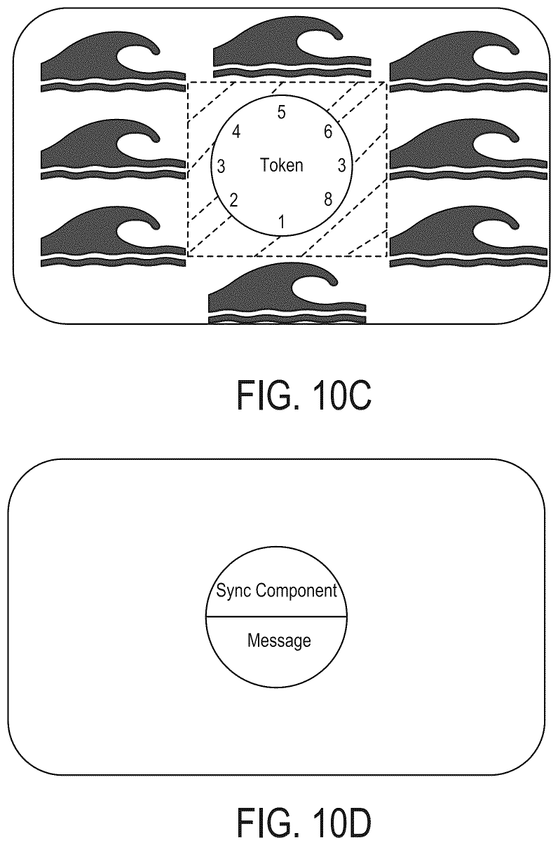

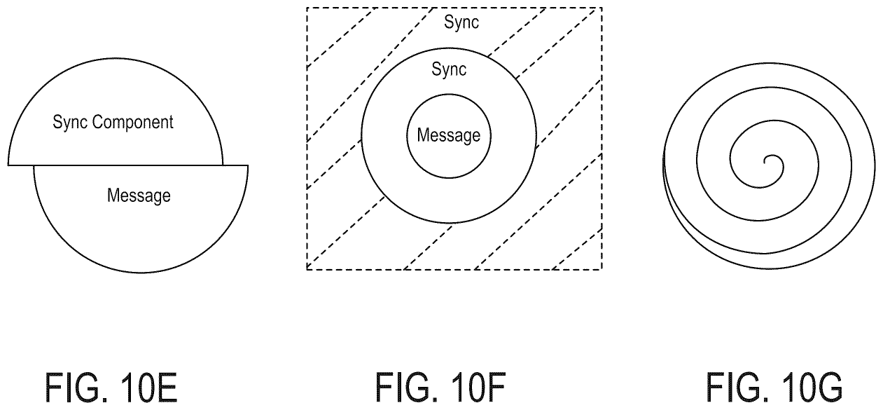

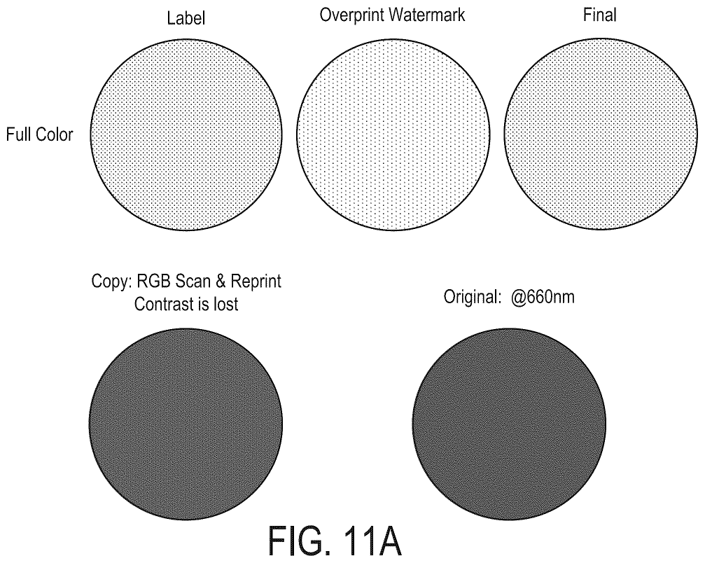

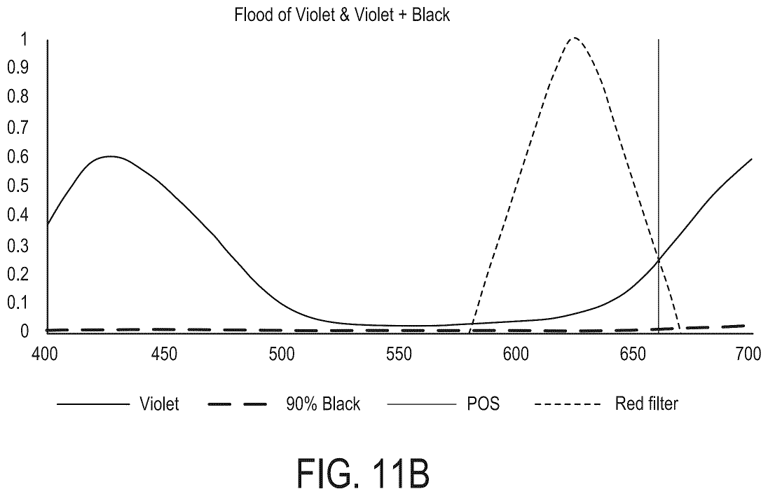

FIGS. 11A-11C illustrate additional split mark embodiments. In FIG. 10A, a value document includes a substrate area having spatially separated synchronization component (dashed line area surrounding a grey circle area) and message component (the grey circle area) provided (e.g., printed) thereon. The synchronization component area preferably does not overlap onto the message component area, but we realize that there may be some ink bleeding or ink running into an area (e.g., into the message component area). An ink trap separation can be used, e.g., 1-3 pixels, to prevent such running. The message component is printed over or on top of an overlayer. A detector can read the message component by using the synchronization characteristics of the nearby (in some cases, surrounding) synchronization component. The overlayer is removable (e.g., peeled or scratched off) to reveal a Token as shown in FIG. 10B. The Token may include printed text, e.g., alpha-numeric numbers, a machine-readable code (e.g., a digital watermark signal), an activation pin or CVV (Card Verification Value) code, identification number, card number, and/or lottery numbers or elements, etc. In one example, the overlayer includes an opaque substance (e.g., a latex or adhesive) printed or flooded over the token, which can be scratched off. In another example, the overlayer includes a sticker that is adhesively attached to a substrate over the token. In still another example, the overlayer includes a laminate that is heat affixed over the core/token. It should be realized that the dimensions and shape of the overlayer in the FIGS. 11A-11C are for illustrative purposes only. We envision other useful shapes including, e.g., ovals, triangles, octagons, semi-circles, etc. Of course, the overlayer can be larger or smaller relative to the core layer. Additionally, the synchronization component need not be confined to a square area and may cover more or less of the substrate. If a circle is used for the overlayer, the synchronization component may be printed in a concentric circle surrounding the overlayer.

In one implementation, the value document does not include a human perceptible 1D or 2D barcode (e.g., carrying a document identification number) printed or otherwise provided thereon. Instead, the Token includes a human readable alpha-numeric code or pin that can be used for value document redemption, activation and/or authentication. The Token (or the spatial area underneath the overlayer) also includes a second message component (the first having been printed on the now removed overlayer) that can be readable in cooperation with the nearby (in some cases, surrounding) synchronization component. This second message component includes or links to the document identification number. This 2nd payload can be encrypted or otherwise protected (e.g., spreading key located) for additional security. In a related implementation, the value document does not include a human perceptible 1D or 2D barcode (e.g., carrying a document identification number) printed or otherwise provided thereon. Instead, the Token includes an activation code or pin and a document identification number, both carried by a non-human readable message component.

In another implementation, with reference to FIG. 10C, the value document does not include a human perceptible 1D or 2D barcode (e.g., carrying a document identification number) printed or otherwise provided thereon. Instead, like one of the above implementations, the Token includes a human readable alpha-numeric code or pin that can be used for value document redemption, activation and/or authentication. The Token (or the spatial area underneath the overlayer) also includes human readable alpha-numeric numbers conveying a document identification number. The arrangement of the numbers is important in this implementation, however, in that they are arranged along the circle edge of the Token area (e.g., the spatial area under the overlayer). While the numbers are arranged in the same horizontal placement around the circle edge, they can alternatively be arranged so that the value document must be rotated to read them face on. E.g., they can be printed in alignment with a normal line at a point relative to the circle's edge (e.g., a line that is perpendicular to the tangent line at a specific point on the circle's edge). The diameter of the Token area (as illustrated, a circle, but alternatively, some other shape) and/or that of the synchronization component area also can be chosen so as to be adjacent to (but not overlapping) graphics, text, designs, artwork, holograms, and/or logos. This way, if a would-be thief removes the overlayer to discover the printed document identification number, and then prints and attaches a 1D or 2D barcode with that document identification number on the document, the printed 1D or 2D barcode would overlay the graphics, text, designs, artwork, holograms, and/or logos, providing a visual theft attempt clue.

In yet another implementation, the value document includes ink printed thereon with red ink. Such red ink generally reflects red light illumination (e.g., illumination with a peak value between 640 nm-680 nm (e.g., a peak at 660 nm)). A message component and/or synchronization component can be overprinted the red ink in a sparse mark pattern using, e.g., black or cyan dots or other print elements. The black or cyan dots absorb red light illumination, and thus are readable to a red light scanner or detector (e.g., as is common at retail checkout stations).

As we did for other embodiments above, let's now explore a theft or tampering attempt for the value documents shown in FIGS. 11A-11C. A thief obtains a value document and removes the overlayer by scratching off the layer or by peeling it off (e.g., in the case of a sticker). See FIGS. 10B and 11C. The thief then has access to the previously obscured Token. This may allow the thief to determine if a lottery ticket is a winner, or in the case of a pre-paid credit card or gift card, access the activation information carried by the Token. The thief then reapplies the sticker over the token. (In the case of a scratch-off overlayer, the thief applies a new latex or adhesive layer to the value document.)

Herein lies an advantage of using a circular shape for the overlayer and Token area. Since there is no inherent orientation with a circle, there is no likely way to reorient the circle as originally placed. Moreover, if the overlayer includes printing thereon, it can be printed with symmetrical artwork or patterns or another non-oriented artwork. The message component can be embedded in these patterns (e.g., by modulating lines, colors, luminance or brightness of elements within the patterns) or overprinted on them (e.g., using a sparse mark pattern discussed above). Sparse mark technology is described, e.g., in assignee's US 2016-0275639 A1, US 2019-0171856 A1, and US 2019-0332840 A1, and in PCT international patent application no. PCT/US19/19410, filed Feb. 25, 2019 (published as WO 2019/165364), each of which is hereby incorporated herein by reference in its entirety. Using a circular shape makes the task difficult for knowing which way is up or down or sideways. The likelihood of reapplying a sticker exactly aligned as it was originally printed is slim, even more so with a circle overlayer and Token area.

An alternative arrangement is shown in FIG. 10D. There, a value document includes an overlayer (e.g., a sticker) having a spatially separated synchronization component (semi-circle above dashed line) and message component (semi-circle below the dashed line) provided (e.g., printed) thereon. The synchronization component area preferably does not overlap onto the message component area, but, again, we realize that there may be some ink bleeding or ink running into an area. An ink trap separation can be used, e.g., 1-3 pixels, to prevent such running. A detector can read the message component by using the synchronization characteristics of the nearby (in some cases, above) synchronization component. The overlayer is removable (e.g., peeled or scratched off) to reveal a Token, e.g., as shown in FIG. 10B. The overlayer can be scored, cut or otherwise perforated along the dashed line so that removing the overlayer (e.g., in the case of a sticker) will break the circle in half. Rearranging the circle so that the top and bottom components are exactly aligned is tricky. FIG. 10G shows another possible cut (or scoring or perforation) pattern, e.g., a spiral cut. Peeling off the overlayer will stretch and skew the original pattern; making reapplying the overlayer in a fraud attempt very difficult. Other cuts or perforation patterns include, e.g., horizonal, vertical and/or diagonal patterns, random perforations or cuts, crisscross cuts, etc.

In a related implementation, the overlayer is printed with a structure that portends to include an objectively correct alignment, e.g., a horizontal sunset, or vertical smokestacks or trees. Arrangement of the overlayer as originally applied is purposefully skewed, e.g., 5-25 degrees off the objectively correct alignment. Human minds crave alignment with our understanding of the world, so it might be natural for a thief to reapply the sticker, once removed, so as to line up with the horizontal or vertical lines. This alignment, however, will affect the alignment of the message component relative to the synchronization component-evidencing a theft attempt. For another example, see FIG. 10E, where the top and bottom semi-circles of an overlayer are intentionally misaligned. This can be a single overlayer shape, including a score, perforation or cut down the middle to facilitate breakage during removal, or two separate pieces. A would-be thief may attempt to align the circles back to form a true circle; otherwise, it will be difficult to guess where the relative alignment of the two pieces was after removal.

To authenticate a tampered-with value document (e.g., overlayer removed and then replaced), e.g., as discussed relative to FIGS. 11B, 11C, 11D, 11E, and 11G, digital imagery depicting the value document is captured, e.g., with a camera-equipped smartphone or tablet. A digital watermark detector analyzes the captured digital imagery to detect the digital watermark signal. Using the digital watermark's synchronization component, the detector evaluates signal elements (e.g., waxels) contained within the digital watermark signal. For example, scale, rotation, and translation values for signal elements are evaluated. The values can be reconciled with one another and/or with threshold values to determine whether they relate to one another within an expected frame of reference or within predetermined values. For example, in the incorrectly rotated circle example, the translation values of overlayer message component signal elements are offset within the frame of reference relative to translation values of synchronization component signal elements. This misalignment (or offset) indicates tampering. As such, the value document can be flagged as fraudulent, tampered with and/or flagged for human inspection. In this case, even though the digital watermark signal may still be decoded in some cases to yield a message payload, the rotation, scale and/or translation values generated from the digital watermark signal components show a misalignment. In other cases, a failure to decode the message component is evidence of fraud or tampering.

With reference to FIG. 10F, another arrangement includes a circular overlayer including a message component within the center of the circle, and a synchronization component surrounding the message component. The synchronization component extends beyond the overlayer (shown with diagonal dashed lines) onto the value document substrate or other layer. A tamper attempt removes the overlayer to access the Token. When the overlayer is replaced, the synchronization component of the overlayer is unlikely to be aligned with the synchronization component on the substrate (or another layer). This will yield a conflict within the synchronization components on the different layers, yielding tamper evidence.

In a still further embodiment, a value document includes an overlayer covering a Token as discussed above. Here, however, the overlayer/substrate layer is processed to include a plurality of holes introduced therein. That is, a hole is introduced through the overlayer and substrate so that you can see through the value document at each hole location. The holes can be laser cut, die cut, etc. The plurality of holes is arranged in a 2D pattern, e.g., a sparse mark pattern as discussed above. The hole locations have a different brightness or reflectivity relative to non-hole areas on the overlayer. This allows a detector to find the brightness/reflectivity difference to decode the sparse mark pattern. Once a would-be thief removes the overlayer, the must realign the overlayer so that each hole in the overlayer is aligned with its corresponding hole in the substrate; otherwise, the sparse mark pattern may fail to read or read with detectable changes. This is a difficult task. Moreso if the overlayer is scored, perforated or cut so as to break during a removal attempt.

Alternatively, an overlayer can be constructed to stretch (and not revert to its original shape) as it is peeled off. This will introduce machine-detectable scale, rotation and translation changes that can be detected upon replacement of the overlayer on the value document.

Another embodiment of our so-called split-mark spatially separates portions of the message component. In this embodiment, the synchronization and portions of the message component are spatially co-located. Portions of the message component are located in different spatial areas of a value document. Recall from above in Section I, a description of a so-called signature. In one example, an error corrected signal included 1024 bits. These 1024 bits can include different payload portions, e.g., a header, payload, error correction bits, etc. The header may tell a detector how to interpret or decode the payload. Let's further say, for example, that in this 1024-bit example, the header comprises the first 50-100 bits of the 1024-bit signature. The header portion of the message component can be confined to (or spread to) a specific value document area, e.g., the overlayer. If the overlayer is removed and replaced (most likely out of alignment with the other digital watermarked areas), the header portion will be unreadable or misinterpreted, yielding a signal read failure.

Now consider additional tamper evident features that can be achieved through combinations of various colored inks and digital watermarking. Generally, print elements (e.g., dots, line structures, etc.) are ultimately used to carry digital watermarking signal elements on printed objects. For example, consider black ink carrying a digital watermark signal that is printed on a white substrate; the black ink absorbs light, and the white substrate reflects light. An image is captured of the printed substrate and represents the different colors (black and white). The captured image is provided to a digital watermark detector. Color (or sometimes, brightness) contrast between the black ink and the white paper is recognized by the detector, which can then decode the digital watermark signal.

With reference to FIG. 11A, a flood or printing of a base Pantone® color, e.g., Medium Purple, is provided over a circular overlayer (also referred to as a “label” in FIG. 11A). A digital watermark pattern (e.g., a sparse mark pattern) is overprinted with black ink (e.g., a 90% screened version of a Pantone® black ink) on the label to yield a Final, digital watermarked overlayer. The overlayer is removable (e.g., peelable or scratch-off) from a value document. FIG. 11B shows reflectivity (Y axis) vs wavelength (X axis in nm) of the Medium Purple base ink and the black ink. Consider two wavelengths in FIG. 11B. The first is at or around 600 nm (e.g., 580 nm-639 nm), which corresponds to a typical red filter on an RGB scanner. The red filter notch is shown with the dashed line in FIG. 11B. There is very little (e.g., less than 8%, preferably less than 5%) reflectivity difference between the Medium Purple and the black ink. The second wavelength is at or around 680 nm (e.g., 660 nm-710 nm). There, the reflectivity difference between the Medium Purple and the black ink is greater than 8% (e.g., 8-25%, preferably between 8-15%). A copy of the label using an RBG scanner with red light filtered at or around 600 nm yields little contrast between the Medium Purple and the black ink. Returning to FIG. 11A, bottom row, the little contrast results in the digital watermark signal being lost or indistinguishable in the copy. This will help defeat a counterfeit attack that involves copying a label, reprinting the label and glueing or adhering it on to a value document. Contrast between the Medium Purple and the black ink in an original label is seen and detectable with a red light scanner with a peak illumination at or around 660 nm (e.g., as is commonly found in red light point of sale (POS) scanners). We use the terms “at or around 660 nm” to include a range of 640 nm-680 nm.

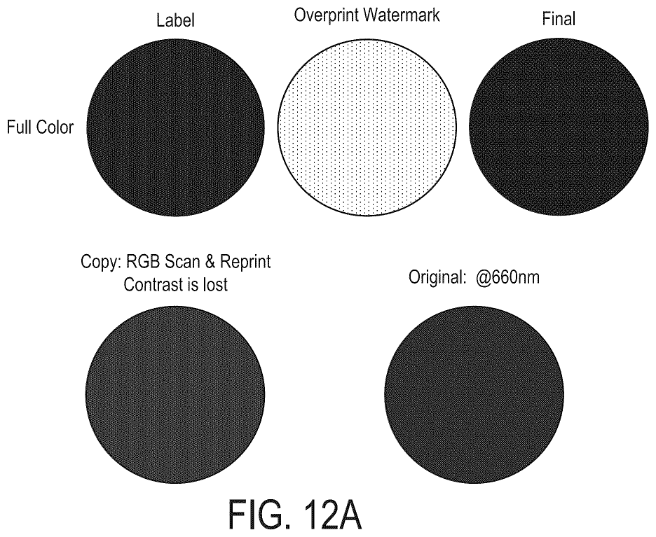

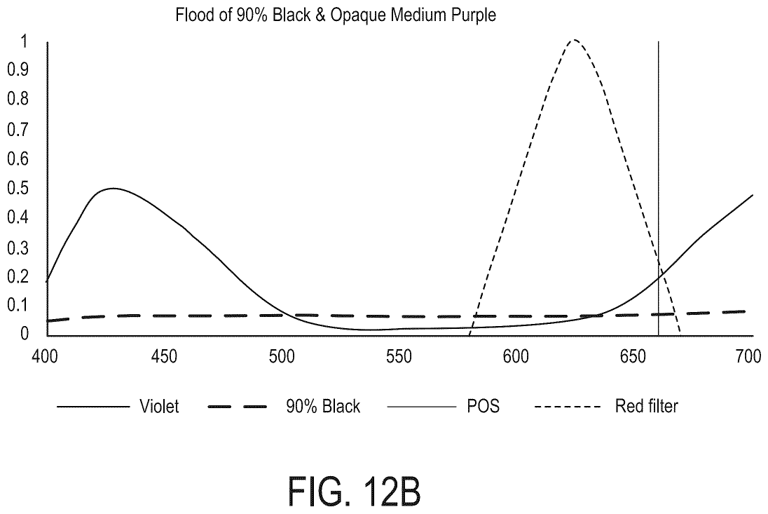

Another implementation is discussed with reference to FIG. 12A, where a flood or printing of a black ink (e.g., a 90% screened version of a Pantone® black ink) is provided on a circular overlayer (also referred to as a “label” in FIG. 12A). A digital watermark pattern (e.g., a sparse mark pattern) is overprinted on the label using, e.g., base Pantone® color, e.g., Medium Purple, to yield a Final, digital watermarked overlayer. The overlayer is removable (e.g., peelable or scratch-off) from a value document. FIG. 12B shows reflectivity (Y axis) vs wavelength (X axis in nm) of the Medium Purple base ink and the black ink. Consider two wavelengths in FIG. 12B. The first is at or around 600 nm (e.g., 580 nm-639 nm), which corresponds to a typical red filter on an RGB scanner. The red filter notch is shown with the dashed line in FIG. 12B. Interestingly, there is a discernable (e.g., 8%-25%) reflectivity difference between the Medium Purple and the black ink. However, the contrast is flipped or inverted, meaning that the signal polarity of the digital watermark signal is inverted. The second wavelength is at or around 680 nm (e.g., 660 nm-710 nm). There, the reflectivity difference between the Medium Purple and the black ink is greater than 8% (e.g., 8-25%, preferably between 8-15%). A copy of the label using an RBG scanner with red light filtered at or around 600 nm yields inverted contrast between the Medium Purple and the black ink. Returning to FIG. 12A, bottom row, left side, the inverted contrast results in the digital watermark signal being detected in an RGB copy. This will help defeat a counterfeit attack that involves copying a label, reprinting the label and glueing or adhering it on to a value document. In contrast, the contrast between the Medium Purple and the black ink is as expected (non-inverted polarity) as seen with a red light scanner with an illumination peak centered at or around 660 nm. See FIG. 12A, bottom row, right side.

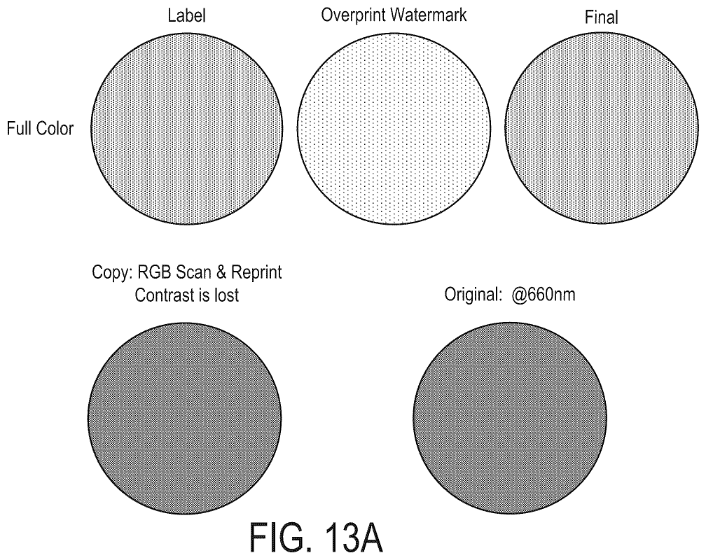

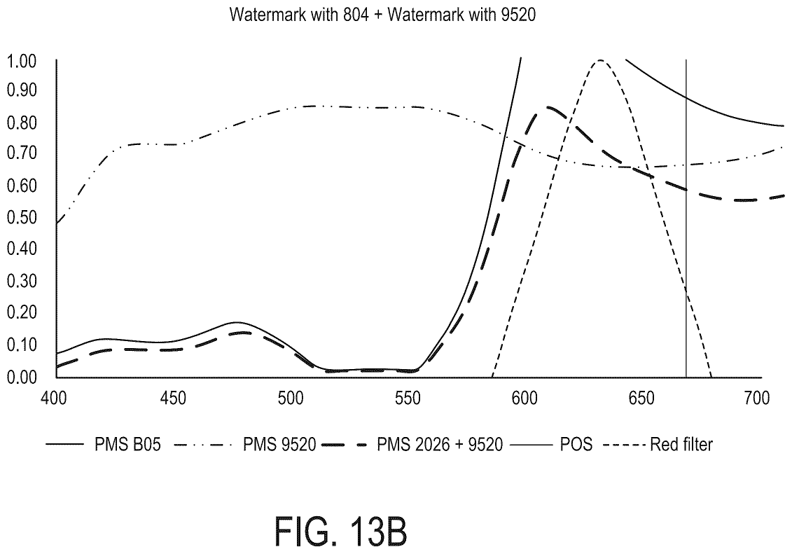

Still another implementation is discussed with reference to FIG. 13A, where a flood or printing of a, e.g., neon or fluorescent orange spot color, e.g., Pantone® 805, is provided over a circular overlayer (also referred to as a “label” in FIG. 13A). A first digital watermark pattern (e.g., a first sparse mark pattern) is overprinted on the label using another ink, e.g., Pantone® 2026 or 804. The flood ink is preferably out-of-gamut relative to an RGB scanner, meaning that it cannot be reliably reproduced. The label, including the first digital watermark signal, receives another printed layer, e.g., Pantone® 9520, carrying a second digital watermark signal (e.g., a second sparse mark pattern) to yield a Final, digital watermarked label. The label is removable (e.g., peelable or scratch-off) from a value document. FIG. 13B shows reflectivity (Y axis) vs wavelength (X axis in nm) of the Pantone® colors 805, 9520, and 2026+9520. At or around the 600 nm wavelength, the first digital watermark signal (or, alternatively, a high-frequency texture pattern) may subtly appear, but there is no detectable contrast for signal detection. Returning to FIG. 13A, bottom row, no detectable contrast results in the digital watermark signal being lost or indistinguishable in the copy. This will help defeat a counterfeit attack that involves copying a label, reprinting the label and glueing or adhering it on to a value document. Contrast between the inks in an original label is seen and detectable with a red light scanner with a peak illumination at or around 660 nm (e.g., as is commonly found in red light point of sale (POS) scanners).

Of course, other inks besides those used in the above FIG. 11A-13B implementations can be used, as long as reflectivity differences at the two wavelength ranges are similar, e.g., providing little to no contrast at or around 600 nm while providing detectable contrast (e.g., 8-40%) at or around 660 nm; or inverted polarity contrast at or around 600 nm and non-inverted contrast at or around 660 nm.

Tamper evident labels are known in the art. For example, such a label may contain, e.g., a layer of adhesive that is designed to separate when the label is peeled away. This separation leaves behind text (e.g., “void” or “opened”) or another message both on the label and on a substrate surface. The pattern or message is typically made using a release coating that bonds either with the adhesive or the label material, ensuring that the pattern or message transfers when the label is tampered with. An improvement for a tamper evident label includes arranging a machine-readable jamming signal with the release coating that bonds either with the adhesive or the label material, or bond with both. In the context of digital watermarking, the jamming signal may include, e.g., a first digital watermark synchronization component. The jamming signal may be subtle, e.g., arranged in a sparse mark pattern or in a continuous manner. The tamper evident label is overprinted with a digital watermark signal, including a second synchronization component that is different than the first digital watermark synchronization signal. The overprinted, tamper evident label is placed on a physical object, e.g., a value document. Now consider a malicious attack against the physical object. The tamper evident label is removed and then replaced, perhaps to access a Token hidden underneath. This removal process separates a layer of adhesive. This separation leaves behind the jamming signal either on the label or substrate surface, or on both. In a first implementation, when the physical object is scanned, e.g., at a front of store location to activate a value document, both the jamming signal and the overprinted digital watermark signal are detected. A detector can be programmed to respond in various ways; including, not communicating a detection of the digital watermark signal or communicating that the physical object is invalid or otherwise compromised. In a second implementation, the first synchronization signal in the jamming signal caused signal interference with the second synchronization signal. This results in a failure to read a message component of the digital watermark signal. Failure to read at checkout indicates that the physical object has been compromised.

Another class of tamper evident labels are so-called “residue labels” or “stretchable tamper-evident labels.” Their primary mechanism is to stretch out of shape when an attempt is made to peel them off, making it difficult to reapply them as originally placed, thus indicating tampering. Stretchable tamper-evident labels are typically made from a flexible, elastomeric material that allows them to stretch significantly. This material might be a form of polyethylene or another synthetic polymer that is both adhesive and elastic. Such labels may include a strong, often acrylic-based adhesive that bonds well to surfaces but is engineered to stretch along with the label material. This adhesive can be strong enough to hold the label in place under normal conditions but allow the label to stretch and deform if someone tries to remove it. An improvement is to include an overprinted digital watermark signal on a stretchable tamper-evident label. Stretching such a label will introduce significant scale and rotation (e.g., even differential scale and differential rotation) such that the digital watermark signal will no longer be readable if reapplied. This results in a failure to read a message component of the digital watermark signal. Failure to read at checkout indicates that the physical object has been compromised.

Some labels may include a fine resolution printing capable of placing holograms thereon. Some of these holograms (or, alternatively, labels without holograms) include line art features and designs, e.g., akin to line art features and designs found in security documents, banknotes, passports, etc. An improvement is to characterize one or more features of the line art and use such as a unique identifier for the label and/or as an authentication mechanism for the label. For example, the technology described in assignee's U.S. Provisional Patent Application No. 63/690,930, filed Sep. 5, 2024, which is hereby incorporated herein by reference in its entirety, can be used to characterize and authenticate a label including line art features and designs. One such combination includes, e.g.: a label comprising: a substrate; line art features printed on the substrate; and a digital watermark signal carried on the label, in which the digital watermark signal includes a synchronization component; wherein one or more characteristics of the line art features serve as an authentication mechanism for the label, in which the one or more characteristics of the line art features are referenced relative to the synchronization component. Another combination includes, e.g.: a method of authenticating a label, the method comprising: capturing an image of a label comprising line art features and a digital watermark signal, the digital watermark signal comprising a message component; analyzing the image to detect one or more characteristics of the line art features and to decode the digital watermark signal to obtain the message component; using the message component, accessing a data repository that includes stored characteristics corresponding to the line art features; comparing the detected characteristics to the stored characteristics; and determining authenticity of the label based on the comparison.

In another embodiment we use a holographic foil, overprinted with digital watermarking, to provide deterrence against copying, e.g., copying attempts using common copiers and/or flatbed scanners and printers.

A holographic foil is a specialized material that produces multicolored light effects through an embossed micro-pattern on its surface. One example manufacturing process may include, e.g.: 1. Starting with a base film made of, e.g., polyester (PET) or polypropylene (PP), which acts as a base or foundation for a holographic foil. This film can be, e.g., flexible and transparent; 2. A master hologram can be created using, e.g., interference lithography or electron-beam lithography, forming microscopic patterns that diffract light. The master hologram can be transferred to a shim (e.g., a durable nickel shim) through electroforming, which serves as a mold for mass production; 3. The holographic pattern can be transferred to a base film by pressing the shim onto the film using heat and pressure. This creates micro-embossed grooves or textures on the film's surface; 4. A thin metallic layer (e.g., aluminum) can be applied to the embossed surface through vacuum deposition. This metallic layer enhances the holographic effect by increasing reflectivity. In some cases, a semi-transparent coating is used for a unique appearance or design; 5. Optionally, a transparent lacquer or UV coating is applied over the holographic layer to protect it from scratches, environmental damage, and fading. This ensures durability and a long-lasting finish; 6. For foils designed for transfer (e.g., such as foil stickers) or stamping, an adhesive layer can be added to enable the foil to bond to various substrates, such as paper, plastic, or metal; and 7. Rolls of holographic foil can be cut into smaller rolls or sheets, depending on the intended application.

In alternative processes, a cold-embossed holographic foil (e.g., for use as a scratch-off sticker) may include a product that combines dynamic visual effects of holography with a scratchable surface and is manufactured using a cold embossing process. This process eliminates a need for heat and is suitable for high-speed, inline production. Unlike hot embossing techniques, cold embossing uses UV-curable adhesives or coatings, along with pressure from a roller, to transfer the pattern without heat. The adhesive hardens under UV light, locking the embossed pattern onto a film surface. For example, a holographic foil can be applied to black or other colored scratch-off paint/ink using a cold stamping method. (E.g., a layer of glue over a scratchable surface, a foil is applied over the glue, and the glue is cured with UV light, possibly with pressure added via, e.g., a roller.)

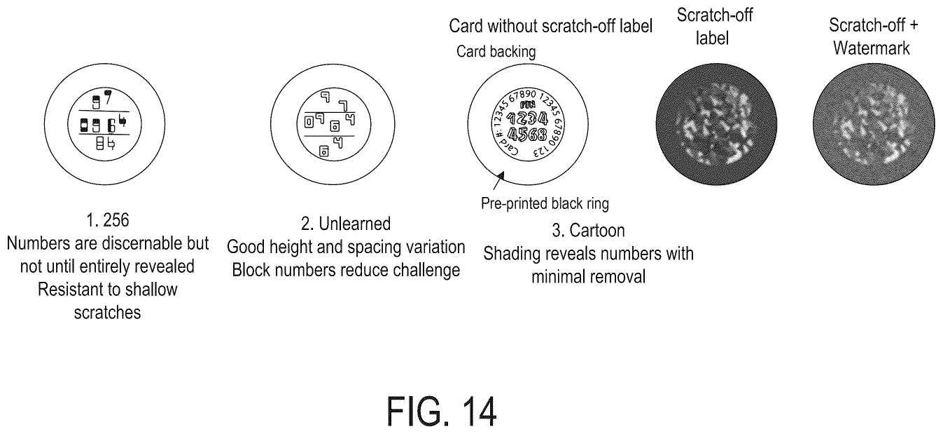

With reference to FIG. 14, a value document surface is printed with information, e.g., value document information such as an identifier number or gift card number, an activation pin, CVV number, etc. The information can be printed within a pre-printed area such as a pre-printed box, rectangle, circle, or ring (e.g., see item labeled pre-printed black ring shown in FIG. 14). Of course, the same printing pass or process that prints the information can also print the area such that the area need not be preprinted.

FIG. 14 depicts 3 different font variants, with varying capability to deter fraud. The font options from best to worst fraud deterrence are labeled: 1. 256, 2. Unlearned, and 3. Cartoon. In option 1, the numbers are discernable but not until entirely revealed. As such, the digital watermark is more likely to be destroyed in a bad actor's attempt to access the value document information under an over-layer, such as a label or card packaging. This font is also resistant to shallow scratches of the over-layer. In option 2, the characters have good height and spacing variation. The block numbers reduce the challenge. Finally, in option 3, the shading of the characters tends to reveal the numbers with less removal of the over-layer. Recommended font attributes are as follows:
Use large type fonts: small fonts make it easier for bad actors to remove only part of the digital watermark;
Incorporate irregularity in spacing, placement, size, and height to reduce predictability;
Homogenous fonts with minimal distinguishing details-avoid unique features that differentiate one number from another; and
Ensure fonts remain easily readable by both humans and OCR systems when fully revealed.

Referring now to the right side of FIG. 14, a holographic foil is placed over the printed information (see item labeled “Scratch-off label” in FIG. 14). This holographic foil can be configured as a scratch-off label (or sticker) or a peelable label (or sticker). A 2D digital watermark signal is then printed over the area (e.g., black ring) and holographic foil. The printing is preferably carried out using an opaque ink, e.g., a white opaque or grey opaque ink. The opacity in the ink reflects light that hits the ink and typically does not allow much light to pass through. Opaque ink may also block the underlying surface or background color (here the holographical foil). We currently anticipate that an ink with an opacity in the range of 30%-65% will work in this embodiment, and likely an ink with an opacity in the range of 35%-60%. If using a white opaque ink over the black or dark area (e.g., black ring), the white will have a strong contrast with the black/dark ink. Overprinting such a white opaque ink then results in a reflectivity contrast on both the foil vs ink and the dark area vs. ink. Signal detection is optimal when there is a reflectively contrast (e.g., between the ink and the foil and/or between the ink and the pre-printed area) in the range of 8-60%, and more preferably in a range of 10%-50%, and even still more preferably in a range of 20%-40%.

With reference back to FIG. 14, we can avoid including a pre-printed area (e.g., black ring) when using a different color opaque ink. For example, in the case where the value document substrate (or packaging around the substrate) is white, we can use an opaque grey ink to carry a digital watermark signal. The grey ink will provide reflectivity contrast vs. the white background and the opacity of the ink (e.g., in the ranges discussed above) will provide contrast with holographic foil. Again, a target reflectivity contrast is typically found within a range of 8%-60%, and more preferably in a range of 10%-50%, and even still more preferably in a range of 20%-40%. The amount of opacity in an ink can be varied to find a desired reflectivity contrast; and the grey level of ink on press can be adjusted by adjusting ink droplet size or print resolution to achieve a target contrast reflectivity within a desired range. In one implementation, a so-called Drop-on-Demand (DoD) print process (e.g., a form of a digital press) can be used to overprint the opaque ink. In other implementations, Lithography printing, digital printing, Flexography printing or Gravure printing is used to overprint the opaque ink.

Using a holographic foil, overprinted with a digital watermark signal, creates a security feature with unique properties when imaged using different imaging platforms. A holographic foil may include a metallic film or, e.g., a silver-colored metallic layer. In terms of light reflection, this metallic layer acts like mirror, only reflects light back when illuminated straight on. Yet, a holographic foil typically includes microscopic patterns causing light also to be reflected back under other angles. This creates different reflective properties when scanned by different imagining platforms. In one platform, such as a red light Point of Sale (“POS”) scanner, a few relatively strong LEDs concentrate light in only few directions, which creates a lower likelihood of seeing a reflection. In another platform, e.g., an RGB flatbed scanner, artwork is illuminated from many different scan directions, this creates a high likelihood of seeing reflections.

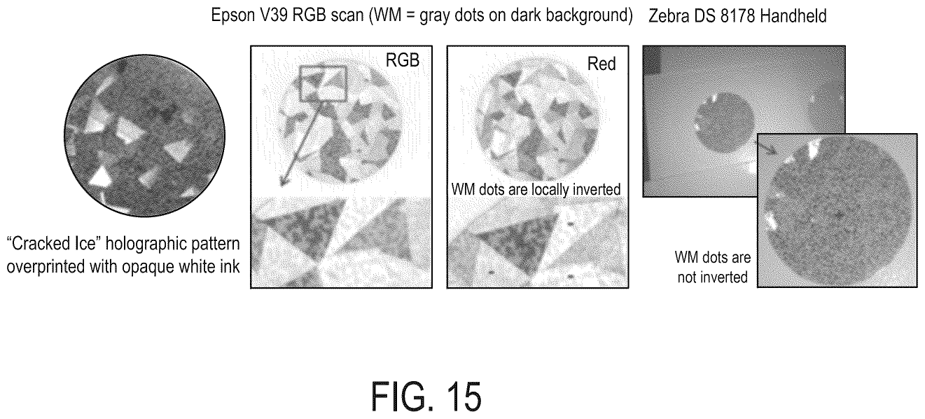

With this context, consider the images in FIG. 15. The left most image shows a holographic foil including a so-called “cracked ice” pattern. The holographic foil is overprinted with an opaque white ink in a 2D pattern so as to convey a digital watermark signal. The digital watermark signal includes a message signal encoded therein, perhaps by the message signal first modulating a carrier signal as discussed above in Section I. The modulated carrier signal can be combined with a synchronization signal as discussed above. Alternatively, instead of using a synchronization component, the contour shape of the holographic foil (e.g., a circle as shown, or other pre-known shape) can provide synchronization for message extraction. The message signal (perhaps after modulating a carrier signal and/or combined with a synchronization component) can be applied to the holographic foil surface by providing ink droplets to represent message elements. (We use the term “message elements” here to include association with or without modulation of a carrier signal, and with or without combination with a synchronization signal.)

The middle image in FIG. 15 shows an RGB scan (e.g., using an Epson V39 scanner) of the digitally watermarked holographic foil. Interestingly, when looking at the red channel image data from the RGB scanner, a subset of (or in some isolated cases, all of) the message element polarity (e.g., plus or minus) are inverted. A watermark detector collecting the message elements from the red color channel will be unable to read the message signal due to the inversion of the subset of elements. Thus, the digital watermark signal will fail to read. In contrast, when the digital watermarked holographic foil is imaged using a POS red light scanner (e.g., a Zebra DS 8178 handheld), the digital watermark message elements are not inverted.

The differing reflective responses to RGB and POS scanners provide a counterfeit detection mechanism. For example, RGB flatbed scanning a value document having a digital watermarked holographic foil as discussed (a common threat by the average counterfeiter) and reprinting will yield a broken (via inverted message elements) digital watermark signal. A rescan of such—even by a POS scanner—will not lead to a successful signal detection.

Of course, there are many other holographic foil patterns that can be used instead of cracked ice including, e.g., rainbow, geometric, honeycomb, wave, mosaic, starburst, spirals, checkered, textures, Guilloche, sparkles, raindrops, and/or lightening.

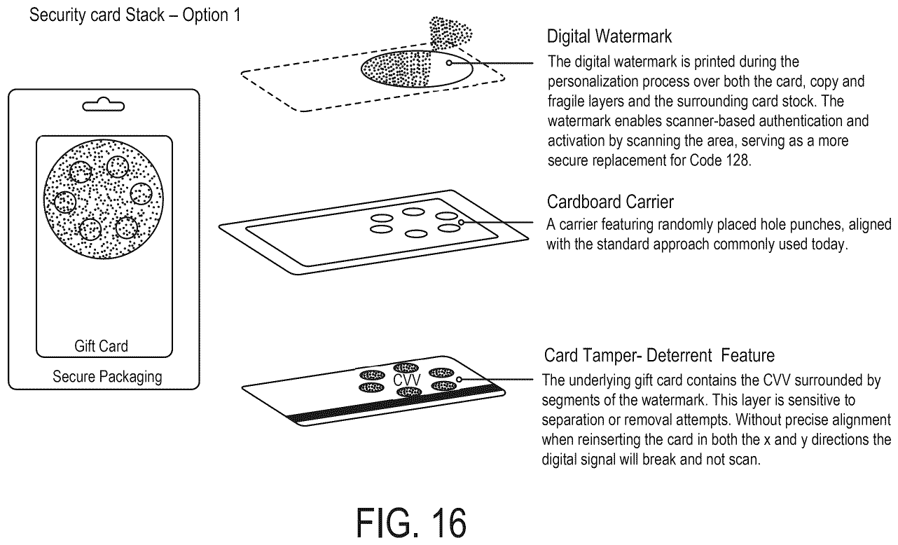

Now consider another embodiment of a securely packaged value document as shown in FIG. 16. For example, a gift card (or other value document) is securely packaged to prevent counterfeiting and/or draining attempts (shown on the left side of FIG. 16). Multiple layers of a secure package are shown in exploded view on the right side of FIG. 16. An assembled secure package can be offered for purchase, e.g., at retail locations. In the FIG. 16 embodiment, the secure package layers include a gift card, a carrier and digital watermarking. Let's consider each of these layers in further detail.

The gift card may include a substrate material, e.g., a plastic such as polyvinyl chloride (PVC), recycled PVC (rPVC), or Polycarbonate (PC), or metal (e.g., stainless steel, titanium, or aluminum), or even biodegradable or eco-friendly materials such as PLA (Polylactic Acid), wood, or even paper-based materials, or composites such as carbon fiber. The gift card may also include, e.g., a magnetic stripe, embedded chips, RFID and/or NFC (Near Field Communication) antenna. The gift card may include one or more protective or decorative laminate layers as well.

A magnetic stripe (or “mag-stripe”) may store encoded data that allows the card to be activated and used, e.g., at a point-of-sale (POS) system. The data stored in the mag-stripe allows a system to recognize the card and link it to an account balance. Data stored in the mag-stripe may include, e.g., Primary Account Number (PAN) (e.g., a unique number assigned to the gift card, similar to a credit or debit card number, linking to an account in a merchant's system), a service code (e.g., a code that helps define how the card should be processed for online or in-store transactions), an Issuer Identification Number (IIN) and/or Bank Identification Number (BIN) (e.g., identifies a merchant or issuer of the gift card), Expiration Date (e.g., some gift cards have expiration dates encoded in the mag-stripe), discretionary data (e.g., some merchants may use this space to store additional internal use data, such as loyalty program identifiers), and/or a checksum or security code (e.g., a validation code to help prevent fraud and ensure the integrity of the card's data). Data can be encoded on the mag-stripe according to the standard ISO/IEC 7813, including Track 1 and Track 2 data. Track 1 may contain alphanumeric characters and often includes a PAN. Track 2 data stores numeric data only, typically including the PAN and checksum.

A gift card typically includes printing, engraving and/or embossing thereon. For example, the printing, engraving and/or embossing may include data, e.g., conveying information such as an account number (or PAN), verification information such Card Verification Value (CVV, an anti-fraud measure, ensuring that the person using the card has physical possession of it), activation number, and/or expiration information. In some implementations, a removable label (not shown in FIG. 16) is adhered to the card surface to cover the printing, engraving and/or embossing or a subset of such (e.g., covering just the CVV or some or all of the PAN). Examples of printing, engraving and/or embossing include thermal transfer, inkjet printing, laser engraving or embossing, dye sublimation, UV printing, DoD printing and/or digital press printing.

A carrier (e.g., formed as a booklet, sleeve, or envelope-style holder) is positioned around a gift card carrier to cover some or all of the gift card. The carrier provides packaging that holds and presents the gift card. For example, the packaging may provide a surface to carry printing, foils and/or holograms for branding and aesthetics. The carrier also provides security and tamper prevention by concealing a card's CVV (as shown in FIG. 16), PAN, PIN, and/or magnetic stripe, etc., thus reducing risk of fraud or theft before activation. A thickness of the carrier may also be chosen to prevent swiping and/or reading of the mag-stripe through the carrier. Gift card carriers can be made from a variety of materials, e.g., paper stock, card stock, cardboard, plastic (e.g., PVC, PET, or biodegradable alternatives), composites, and/or recycled versions of the foregoing. As shown in FIG. 16, the carrier may include a plurality of openings or holes. While the openings are illustrated as circles, other opening shapes and sizes may be alternatively used such as rectangles, squares, ovals, octagons, diamonds, stars, spiral, etc.

Once the carrier is packaged around the gift card, a layer of digital watermarking can be printed thereon. The digital watermark technology described above and in the incorporated by reference patent documents can be used in this and the following embodiments. While the digital watermarking is shown as confined to a circular spatial area in FIG. 16 (left side), it need not be so. If the carrier includes a plurality of openings, as shown in FIG. 16, however, we preferably arrange the digital watermark to print at least a portion of the signal on the carrier and at least a portion of the signal through the openings of the carrier and onto a gift card surface. For example, the gift card layer shows that the digital watermarking is printed within six (6) circular spatial areas corresponding to the carrier openings in the exploded view (right side of FIG. 16). The digital watermark includes a payload, e.g., carrying an account number or PAN information. At checkout, a cashier scans the digital watermarking layer on the carrier and card to obtain the payload (e.g., an account number). The POS system then links the card's account number (perhaps via a 3rd party network) to an account and loads the desired balance. A PIN or activation number, CVV and/or expiration date may be used to complete activation in some implementation. For example, the carrier may include a rip tab or other opening mechanism to access a covered PIN, expiration date or PIN at checkout. In other examples, the carrier (or card) may include a label hiding such information. At checkout, the label is removed (e.g., peeled or scratched off) to access the activation information. We prefer that no barcode is printed on the carrier or gift card, but some embodiments may use a combination of barcode information and digital watermark information for activation.

One example fraud attempt involves stealing a securely packaged gift card from a retail location, removing the gift card from the carrier (e.g., to read the mag-stripe and/or activation data), repackaging the gift card within the packaging, and returning the repackaged gift card to the retail location in hopes that an unsuspecting shopper will activate the now tampered with card.

An advantage of the FIG. 16 securely packaged gift card is that a thief would need to replace the gift card so that the digital watermarking is aligned in both the x and y directions. Otherwise, the digital watermark signal may not read. (We note that had a 1D barcode been used instead of the digital watermarking, a read may still be obtained by proper alignment of a card within a carrier in the x direction (bar width direction) only, since the long lines in the y direction (line length direction) are much less sensitive to misalignment.) There are many ways to achieve this digital watermark alignment sensitivity. For example, above we discussed spatially separating the message (or payload) component and the synchronization component. Here, in this embodiment, only message components are spatially provided so as to be printed through the carrier openings and onto the gift card surface. The synchronization component can then be spatially printed around (but not in) the carrier openings. Misalignment of the payload component relative to the scale and rotation information provided by the synchronization component indicates a tamper attempt or may fail to read altogether. In other cases, a payload is segmented, and each segment is only printed in one of the opening areas. Each of the payload segments must be read and then concatenated or otherwise combined to yield the entire payload. Misalignment of any one of the opening areas will result in a failed payload read. In still a further example, the message component of the payload is sub-divided into portions and distributed to different spatial regions, such as card, label, and/or card carrier in a manner that requires each of these components to be intact and/or properly aligned to produce a valid read when scanned. This functionality may be further optimized by positioning portions of the synchronization and message components selectively on one or more parts of the card, label, or carrier so that all components need to be present and aligned to produce a valid watermark read of the watermark signal applied across spatial regions of the card, label, carrier, etc. Further, in addition to selectively locating these components, the robustness of each component may be adapted to increase or decrease it selectively per component location to achieve the desired tamper evident effect. Robustness may be adapted by controlling the signal strength, redundancy, and/or introducing entropy or interference for a portion of each message and/or synchronization component. The message components include controllable robustness parameters, such as error correction, modulation onto a carrier signal (e.g., spread spectrum modulation), and repetition coding, each of which present an opportunity for adjusting robustness selectively. The synchronization components include controllable robustness parameters, too, such as signal strength, signal removal (e.g., either of frequency components or spatial components or spatial coverage). We provide additional examples of this form of signaling (referred to as TamperMark) below.

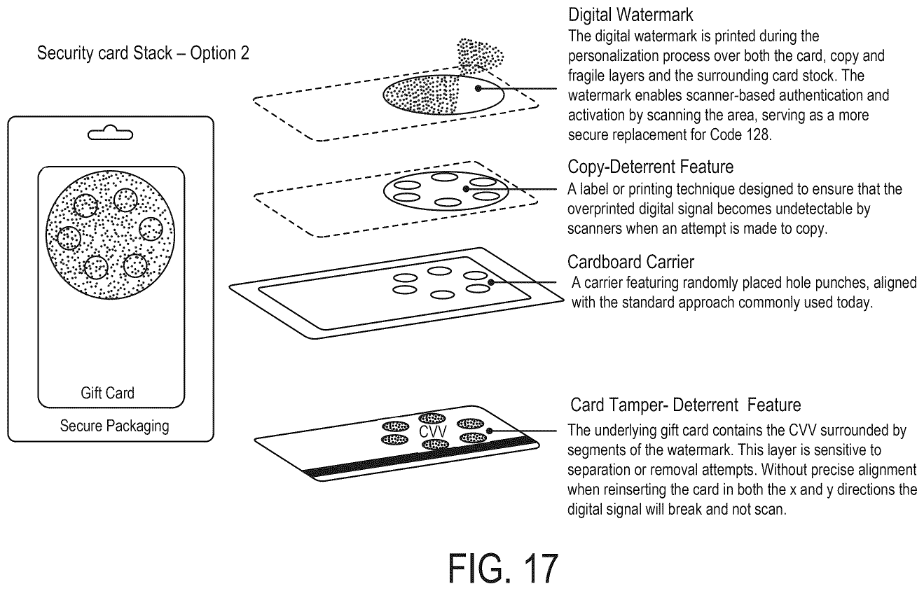

Referring to FIG. 17, another securely packaged gift card embodiment is shown. This embodiment includes the secure packaging features discussed with reference to FIG. 16, along with an additional copy-deterrent feature placed over the carrier. This feature can be affixed or attached to the carrier using various methods, such as adhesive, glue, hot or cold stamping, UV curing, or printing adhesives followed by curing, before any openings are made in the carrier. The openings then can be created through both the copy-deterrent feature and the carrier in a single process (e.g., punching or cutting), ensuring spatial alignment of the openings between the two layers. This arrangement allows a digital watermark signal to be printed on the copy-deterrent feature, as well as on the gift card surface through the aligned openings. In some implementations, the digital watermark extends beyond the copy-deterrent feature and onto the carrier itself.

The copy-deterrent feature preferably obscures, interferes with and/or alters the digital watermark signal during image capture via an RGB flatbed scan or mobile smartphone camera capture. One example of a copy-deterrent feature is the holographic foil discussed above with reference to FIGS. 14 and 15. Digital watermark signal elements are locally inverted (e.g., due to reflective properties of the holographic foil) in an RGB scan but not a POS (red light) scan, which renders the digital watermark signal unreadable in the former but not the latter. If a synchronization or other component is printed in the spatial areas of the copy-deterrent feature surrounding the openings, the signal will be distorted (e.g., due to local inversion) in a copy image. Other copy deterrent features may be provided as the copy-deterrent features using, e.g., holograms, foils, color-shifting ink (e.g., optically variable ink or OVI, which appears as one color when viewed at a certain angle and shifts to another color when tilted, a scanner only captures a single angle of light, making it difficult to replicate the color shift); transparent window film or clear elements (e.g., scanners typically cannot replicate transparency, leading to dark or blank areas in a copy); iridescent or pearlized coatings (e.g., which reflects light at different angles, producing a shimmering effect, scanners cannot capture light refraction accurately, leading to dull or incorrect colors in the scanned copy); and/or metallic coatings.

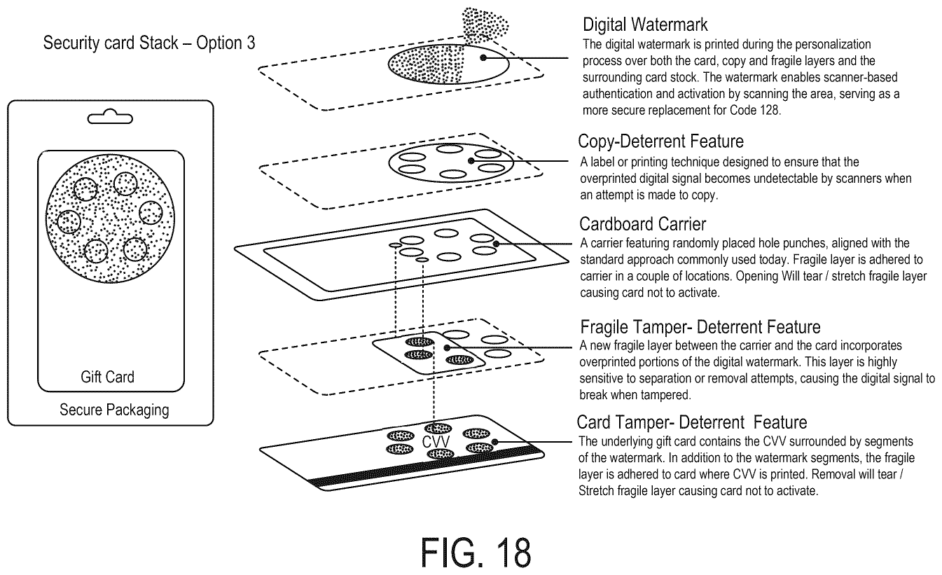

Still another embodiment of a securely packaged gift card is shown with respect to FIG. 18. This embodiment generally includes the secure packaging features discussed with reference to FIG. 17, with modifications as described below, along with a fragile tamper-deterrent (“FTD”) feature placed between the carrier and the gift card. The FTD feature is sensitive to separation or removal of the gift card from the carrier, e.g., stretching or tearing upon removal attempts. This FTD feature can be adhered (e.g., with an adhesive or glue) to both the carrier and the gift card. For example, the FTD feature may include adhesive or glue at a spatial location of the CVV or other use or activation information. Thus, an attempt to fraudulently discover the CVV information will likely result in deformation or destruction of the FTD feature. Otherwise, adhesives or glue can be placed in the corners, middle edges or as otherwise determined to yield a destruction or deformation of the FTD feature. Different adhesives or glues can be used, each with a differing adhesion strength, to cause uneven force to remove the FTD layer from the card.

As shown in FIG. 18, the FTD layer includes only a subset of openings compared to the carrier and copy-deterrent feature. For example, the FTD feature may include only half of the openings (or more or less) but not a complete set of openings relative to the carrier and/or copy-deterrent feature. This is preferable because at least some of the digital watermark signal should be printed on the FTD feature through the openings in the carrier and copy-deterrent feature. The printed digital watermark signal on the FTD feature will stretch, tear or otherwise deform upon card removal from the carrier. As discussed above with respect to FIGS. 17 and 18, the digital watermark signal preferably includes at least two components, a synchronization component and a message (or payload) component. Message components may be printed in the opening areas, and the synchronization component can be printed in areas surrounding the openings, or vice versa. If the message component on the FTD feature becomes stretched, torn or otherwise deformed (e.g., during a card-removal-from-carrier and replacement attempt), scale, rotation, translation (e.g., zero offset) and, likely, differential scale and differential rotation, will be introduced into the digital watermark signal on the FTD feature. A digital watermark detector will have a difficult, if not impossible, time trying to resolve the new distortion when trying to detect the message component. Said another way, the synchronization component carried on the carrier and/or copy-deterrent feature will provide scale and rotation information that will be inconsistent with the scale, rotation, translation, differential scale and/or differential rotation introduced to the digital watermark signal on the FTD feature, resulting in an unsuccessful signal read. The digital watermark signal separations discussed above with respect to FIGS. 17 and 18 can be used for spatially arranging other separate signal configurations. (Although not illustrated as such in FIG. 18, a related implementation includes the features discussed relative to FIG. 18 except for the copy-deterrent feature.)

Example materials for the FTD feature may include, e.g., stretch-indicating materials such as elastic polymer films (polyethylene (PE) or polyurethane (PU) films adhered with, e.g., an acrylic adhesive), which deform upon stretching; destructible fragile vinyl (polyvinyl chloride (PVC) or pressure-sensitive adhesive that bonds tightly to surfaces) that tears or breaks into pieces upon stress; tamper-evident adhesive materials (thin polystyrene or acrylic-based fragile films which break when pulled), which are thin and brittle and break apart when stressed; thin or brittle paper or tissue; elastic polymers with perforations or cuts; among others.

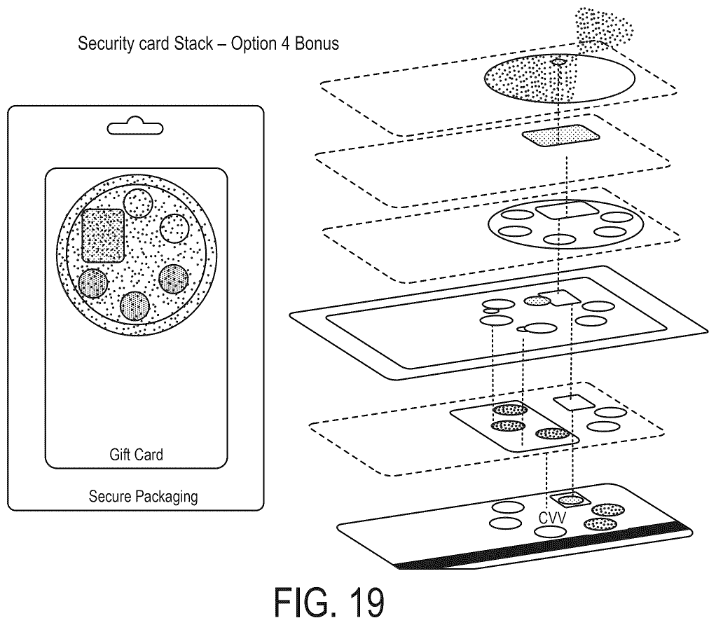

A related embodiment is now described with reference to FIG. 19. This embodiment generally includes the secure packaging features discussed with reference to FIG. 18, with modifications as described below, along with a tamper-deterrent label (“TDL”) feature placed over the copy deterrent feature. This is a destructible or tamper-evident layer over the carrier. This layer is sensitive to separation or removal attempts. The layer can be adhesively attached to the carrier, FTD feature (via an opening in the carrier) and even the gift card (via an opening in the FTD feature). This feature evidences a tamper attempt upon encountering a stress like pulling a card from the carrier. Example materials may include, e.g., fiber-tearing materials (Laminated paper with void-release adhesive to create tearing effect and adhesives designed to bond with fiber materials); thermochromic (heat-sensitive) material (e.g., thermochromic liquid crystal inks embedded in PET film). Digital watermarking can be printed on this feature so that when it evidences tampering the digital watermark signal is lost or flooded with noise from the tampering. This results in a failed read.

The ink opacity and reflectivity difference discussed above with respect to FIGS. 14 and 15 can be used on the FIGS. 16-19 embodiments, e.g., if the copy-deterrent feature includes a holographic foil or other copy fooling material (e.g., holograms, OVI inks, pearlescent inks, etc.).

Another related embodiment includes using so-called IR Fluorescent Phosphor dyes and inks, e.g., such as those provided by LDP LLC at the website MaxMax.com. Such dyes and inks absorb (e.g., excites) light frequency in the red spectrum (e.g., absorbs in a range of 620 nm-710 nm, or as in one example, absorbs within a range of 600 nm-680 nm) and emits (e.g., fluoresces) in the Infrared spectrum (IR) at or above 710 nms (e.g., the near through mid-IR, 710 nm-3.8 μm. We can use such inks or dyes for the, e.g., digital watermarking layer and/or the copy-deterrent feature shown in FIGS. 16-19. An ink or dye that absorbs at or around 660 nm will show a darkening effect at an ink or dye spatial location in an RGB scan. These RGB scanners filter light within individual color channels to obtain red, green, and blue colors. In contrast, a red light LED scanner, e.g., as typically found in a POS scanner, does not typically cut off or filter IR frequencies. This will result in a light or bright response at the dye or ink spatial location as seen by a POS scan. This enables a copy deterrent feature since a digital watermark signal carried by such IR Fluorescent Phosphor inks or dyes will yield a first reflective response (e.g., as expected to carry a digital watermark signal) with a POS retail checkout scanner, but a second, different reflective response with an RGB scanner.

There are various security features that can display different images upon changing a viewing angle. We've already discussed holographic foil, holograms and OVI's above. Another example is SICPA's QUAZAR® product. From SICPA's website, https://www.sicpa.com/news/sicpa-reynders-join-forces-fight-against-fakes “QUAZAR® is a practical solution that can be used to authenticate pharmaceutical products, electronic and automotive components, apparel, food and spirits, and other high-end consumer products. Delivered in the form of a unique product security label, QUAZAR® empowers consumers, businesses, and government officials to easily and reliably validate authentic goods and products.”

One security implementation utilizes holograms, OVIs and/or QUAZAR labels (collectively and individual a security feature), each with at least a first image (e.g., different colors or different artwork) and a second image that are only viewable, respectably, at a first viewing angle and a second viewing angle. Such a security feature is provided on a substrate. A digital watermark signal including at least a synchronization component and a message component is printed around the security feature. The synchronization component provides a relative orientation of the security feature. A smartphone app can be provided with a digital watermark detector (or which calls a digital watermark detector). The smartphone captures a first image of the security feature and surrounding digital watermarking. The digital watermarking from the image is decoded to determine a first relative orientation. Using the digital watermark signal (e.g., an origin of a first tile or a corner location of the digital watermarking), a center reference point is established that likely includes the security feature. Color data is determined for the center reference point or neighborhood of points around the reference point (e.g., sRGB color data). The app then prompts the user to tilt the security feature/digital watermarking to an angle relative to the first image capture. A second image frame associated with a desired tilt or angle is captured, and the same central reference point is found (using the digital watermark signal). Color data is sampled and compared with the color data from the first image frame. The security feature is validated when the color data evidences a predetermined change (e.g., as determined with a distance function or color error).

Our testing revealed a degradation in watermark robustness when reading the digital watermark using a POS scanner due to a parallax effect. When viewed at an angle (e.g., from a POS scanner's bottom plate), the digital watermark on the card appears shifted relative to the one on the secure package (the cardboard carrier shown in FIGS. 17-20). The 0.3 mm package thickness plus the air gap creates a shifting of the digital watermark waxels on the card relative to the package when viewed from an angle. As a result, the misalignment due to this shifting distortion exceeds the robustness tolerance of the digital watermark, causing the watermark detector system to misinterpret a valid card product as being tampered with. However, when viewed straight-on, no shift occurs.

To address the parallax problem, one solution is to reduce the gap between the layers. This may be achieved by making the secure package paper thinner. Another alternative is to fill the holes in the package with a glue layer that the DoD ink adheres to but then transfers with the card when tampered. Yet another solution is to adapt the robustness of the digital watermark on the card to accommodate the shifting. We discuss these solutions further below.

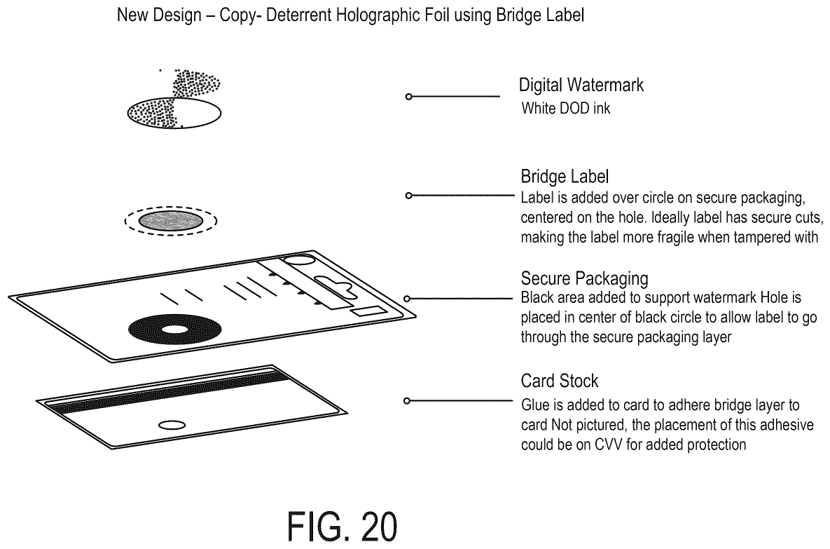

FIG. 20 depicts an embodiment of a securely packaged value document, with a bridge layer to mitigate the parallax effect. In this example, the value document is a gift card, and the secure packaging serves as a card carrier substantially enclosing the card. This embodiment comprises card stock, secure packaging, a bridge label and a digital watermark printed with DoD printing. Glue is added to the card to adhere the bridge layer to the card. The placement of this adhesive could be on the Token (e.g., CVV) for added protection. A black area is printed on the packaging to enhance readability of the digital watermark. A hole through the packaging is located in the center of black circle to allow the bridge label to pass through the secure packaging layer and adhere to the card. The bridge label is added over this black circle on secure packaging, centered on the hole. Preferably, the bridge label has secure cuts, making the label more fragile when tampered with. Finally, the digital watermark is printed over a circular region that spans both the secure packaging and card.

The bridge label covers the cutout and attaches through it to the card. This configuration smooths the depth transition, improving watermark readability. When the card is removed, part of the label remains on the card, while the rest stays attached to the packaging. Security cuts in the label tear the printed digital watermark into fragments, making re-insertion ineffective.

Design considerations include label thickness, inclusion of a holofoil, security cuts to enhance tamper evidence, and use of fragile layers.
Label Thickness: Should be optimized to create a smooth transition between the packaging and the card, preserving watermark robustness.
Holofoil: Bridge label may include a holofoil layer to deter against common copy workflows.
Security Cuts: Small perimeter cuts around the packaging cutout would ensure that the portion glued to the card detaches from the main label, breaking the watermark.
Fragile Layers: Labels with holofoil show that the ultra-thin holofoil top layer (carrying WM in white DoD) can peel off when lifted with tape. This helps prevent fraudulent reattachment if an attacker tries to remove the card and hold the bridge label in place by tape.

The steps of manufacturing card carrier embodiments and digital watermark application include the following:
1. Manufacture the label with copy-deterrent surface, such as colored background, or with holographic foil. The label may have an additional digital watermark signal common to all labels to deter copy counterfeiting. The label may be circular, rectangular, or other shape, with an adhesive forming a sticky region all around, or with inner portion not being sticky aligned with the cutout location of the hole.
2. Print the back of the packaging without the label being applied and cutouts made. The back of the packaging may be pre-printed (e.g., with a black layer as in FIG. 20) to allow for DoD ink to have contrast against the pack background, such as dark (under red) background for white DoD ink.
3. Apply the label on the outside back of the packaging over the pre-printed background. As shown in FIG. 20, the label is positioned to cover the pack cutout from outside to smoothen or bridge the transition between different heights. The label bottom, through the cutout, may be sticky, or not. The adhesive may be selectively placed on the label core material.
4. Affix the card to the back of the pack using glue. The card may either stick to the label through the cutout, or if the label is made without a sticky center, glue could be used to fill the gap between label and card caused by the pack thickness (which is about 0.3 mm).
5. Print a serialized watermark with card data over the label and back of packaging. The printing of this ink “cements” the location of the label with the packaging, like the scratch-off label embodiments described above, providing tamper evidence against label removal/re-positioning.

The post printing (“cementing”) of the digital watermark over the label and packaging of step 5 is a preferred option. For example, a 1.5″ black donut is printed on the packaging to form the above-mentioned black area of ink. Then, 1″ circular holographic label is aligned in the center of the donut, covering a ½″ hole cutout in the packaging affixed on the card.

1D and 2D barcodes will have similar behavior when printed at different depths and this bridge label configuration is also applicable to such symbologies.

### Label Considerations

To enhance tamper evidence, the label is made with heat-sensitive elements allowing the label to change color or destroy the background holographic effect making the digital watermark no longer activate when heat is applied to soften the glue in a tampering attempt.

Preferably, the label should have a brittle layered structure such that when tape is used to hold it in place, the top layer of the holographic foil will stay glued to the tape and tear the digital watermark printed in white ink. This may be achieved by having a weak bond between the foil layer and label base, such as used in scratch-off labels.

### Label Layers

An implementation of the layers of the label of the embodiment shown in FIG. 20 are as follows from top to bottom:
1. Topcoat allowing Drop on Demand inkjet printing to adhere to the label: The topcoat seeks to match the DYNE level of the label with the ink, allowing ink to not “ball” up and adhere to label;
2. Thin holographic film with silver backing to reflect light, or with no backing—e.g., transparent;
3. Label base material; and
4. Adhesive placed selectively based on location, as described above.

### Digital Watermark Tamper Regions

The tamper evident digital watermark signal is designed such that digital watermark reads in a pristine state and breaks when (1) the label is removed from packaging (2) the card is removed from packaging, tearing the label center section as it is glued to card. Glue should be heat resistant, not softening when heated. This heat resistance makes it harder for the attacker to remove the card more easily.

Above, we explained various embodiments in which the robustness of the digital watermark is adapted to provide desired tamper evident performance. These embodiments include digital watermark configurations we referred to above as TamperMark. Here, we elaborate further on methods to adapt robustness and perform Quality Control to assess whether the digital watermark is within desired tolerances.

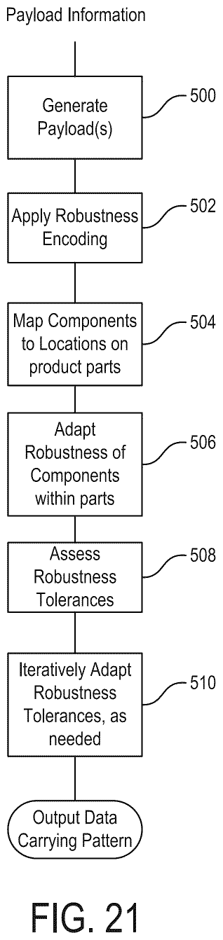

FIG. 21 is a flow diagram illustrating a method of adapting the robustness of a signal carrier to enable detection of tampering. This method is designed to be implemented in the preparation of digital watermarks or optically readable symbologies to be applied to any product or label, including value cards. The method starts by generating the payload (500). This is accomplished, for example, by executing the processes described above in connection with module 300 in FIG. 3 (as further described in FIG. 6). Specifically, the payload may comprise information symbols and error detection symbols, derived from the information symbols of the message. In one implementation, the method computes the error detection symbols (e.g., the output of a CRC function) from the information symbols and concatenates them to the information symbols. Next, the method applies robustness encoding to the payload, which includes one or more of error correction encoding, spread spectrum modulation, repetition coding, and/or the like. Implementations of robustness encoding are described further above in connection with the processing of modules 302, 304, and 306 of FIG. 3. The output of robustness encoding is a set of message components comprising encoded message symbols (e.g., binary or M-ary symbols).

Next, the method maps the resulting message components to locations on the product parts (504). For value documents, these parts include the card and an overlayer, such as a label or packaging, such as a card carrier. The objective of the mapping is to identify message components that reside on the parts of the product in preparation for the next steps of adapting robustness of these components. By varying the robustness of the message components within each part, the method enables automated tamper detection because it sets tolerances on the robustness of the message that are exceeded when the product parts are tampered with. For example, on a value card, the method adjusts the robustness of the message components on the card relative to the label or carrier to require that each part be present and not altered for the signal decoder (e.g., FIG. 2) to read the complete message successfully.

In processing module 506, the method adapts the robustness within the part or parts. We have developed variations of this process. In a first variant, the error correction encoded bits (the signature) are subdivided into portions. For each portion, the method identifies locations of the spread spectrum modulated bits corresponding to each portion residing in the different parts of the product. For a first portion that corresponds to locations on a first part, the method randomly selects and then modifies modulated bits to decrease robustness. It achieves this by introducing entropy, specifically, by selectively modifying the message bits of the first portion on the first part (e.g., flipping them or otherwise nullifying them) so that they appear as noise to the signal decoder. The method does the same for the second portion on a second part, taking care to reduce the robustness of the message conveyed in the second portion on the second part. The effect of this is to make it necessary for un-altered message components from both parts of the product to be present to enable a successful read of the message spread across both parts.

In a second variant, we achieve a similar effect by an alternative means with some additional benefits. The second variant creates two versions of the error correction encoded signature: a first with no modification to the payload bits, and a second where it randomly modifies selected bits of the payload. The method then compares the two versions to identify bits within the error correction encoded signature that change because of the modification. The locations of the message components corresponding to these identified bits, termed relevant bits, are then identified on the product parts. For example, the locations of the message conveying the relevant bits are identified on the card, on the one hand, and the package or label, on the other (depending on the embodiment). Next, the method adapts the robustness of the message components of the relevant bits a first way on a first part (the card) and a second way on a second part, such that both parts need to be present and substantially un-altered to yield a successful read.

This second variant provides an additional benefit in that it provides a way to increase the robustness of the message selectively to address the parallax problem. To enhance robustness to shifts of waxels on the card relative to the package, this “relevant bits” approach dilates the ink modifications that encode these relevant bits of the message (e.g., corresponding to ink or no ink components). The dilation operation may extend the relevant bit encoding up/down and left/right, or like dilation function, with the objective of increasing likelihood of accurate message recovery from different viewing angles (e.g., those corresponding to shifts in the directions of the dilation). The method further takes care to minimize collisions where dilation of nearby relevant bit encodings would conflict with each other. The second variant alters the message components corresponding to relevant bits on the package to reduce their robustness, e.g., by flipping or otherwise nullifying their contribution to successful message decoding. Thus, the second variant creates a tamper evident feature by selectively increasing robustness to shifts for the message on a first part, (e.g., the card), while reducing robustness of message components on a second part (e.g., the package). Both parts need to be present and remain substantially un-altered to yield a successful read.

As noted previously, the process of adapting the robustness may also include adapting the robustness of the synchronization component in the respective parts. This may be achieved by removing the synchronization component in selected areas corresponding to a first part, and/or increasing the signal amplitude in another part, to decrease or increase robustness, respectively, of the synchronization components in the parts.

In addition to varying the message and synchronization components, the method may adapt robustness by iteratively selecting different payloads, portions of payloads, and different placement and coverage, to further generate digital watermark signals that achieve desired tamper evident properties.

Next, in processing module 508, the method assesses the robustness of the digital watermark. It does so by determining the message detection score, noted above. The signal strength of the synchronization signal may also be measured to assess robustness of the digital watermark. If the robustness assessment indicates that robustness does not fall within desired ranges, the method iteratively adapts the robustness by updating one or more of the parameters: payload, payload portion selected for robustness modifications, placement of modified and un-modified components, dilation, etc. When the desired tolerance is achieved, the method outputs the data carrying pattern (e.g., the digital watermark described, like optical code). Through this approach, the method generates tamper detection messages that enable both reliable activation of valid product via scanning via mobile, POS, or like-camera based device, as well as reliable, automated tamper detection of altered products, with conventional devices.

### Heat Threats

In various implementations, we have seen that glues used in labels and in connecting front and back portions of secure packaging are sensitive to heat. At approximately 160° F. (e.g., 150° F.-170° F.), these glues (or adhesives) begin to lose their bonding capabilities and soften. At approximately 200° F. (e.g., 185° F.-215° F.), the glues melt, potentially allowing a label to be removed from a value document to reveal hidden information, e.g., a PIN, CVV, or other information, or enabling value document components to be separated, providing unauthorized access to the contents. When cooled back to room temperature (+ or −10 degrees), the glues or adhesives regain their functionality, leaving the label adhered to the card without visible signs of tampering.

To address this vulnerability, we have developed several heat-resistant security features that can be incorporated into value documents.

Heat-Responsive Label Materials. One implementation uses heat-shrink label base material. Conventional scratch-off labels are manufactured by printing pressure-sensitive glue and scratch-off ink layers on a clear plastic base film, typically made of PET that is not heat-sensitive. In this configuration, the glue layer melts before the base film is affected. When digital watermarks are printed over such scratch-off labels to create a tamper-evident seal between the value document and the label, heating can cause the glue to melt, potentially allowing partial access to hidden information while keeping a portion of the label intact.

To counter this vulnerability, the clear label base material can be made heat-sensitive, causing it to physically shrink before the glue melts when exposed to heat. This can be achieved by using heat-shrink plastic films specifically designed to deform when heated, such as PVC or PET-G heat-shrink films. The label can include “security cuts” that further allow the glued label material to shrink and irreversibly distort the digital watermark signal when exposed to heat. Polystyrene can also be used as a material for the base film, providing effective heat-shrink capabilities that trigger before adhesive failure occurs. Distortion of the digital watermark signal will render it unreadable. Lack of a digital watermark signal detection, when one is expected, is an indication that the value document has been tampered with or is otherwise defective.

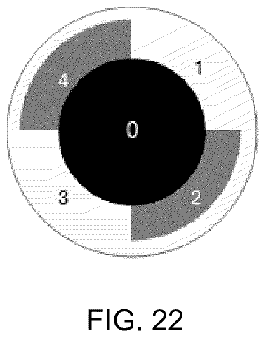

Thermochromic inks provide several security options for value documents:
1. Clear-to-Bright Thermochromic Ink: A clear ink that becomes bright (particularly under 660 nm illumination) when heated can be applied over a scratch-off label or holographic foil pattern. The resulting color change introduces a contrast change that disrupts the digital watermark's readability. Disruption of readability is again an indication that a value document carrying the digital watermark has been tampered with or is otherwise defective.
2. Clear-to-Black Irreversible Ink: These inks appear clear (e.g., colorless) at a base temperature (e.g., for this document, a “base temperature” includes a range equal to or between 30° F.-100° F.) and turn black when heated to a specific temperature, e.g., approximately 160° F. to approximately 200° F., never returning to their clear state even when cooled back to a base temperature. A digital watermark may be applied over a design area using clear-to-black ink, creating a “tampered” indicator that can be detected by point-of-sale systems, triggering a security event such as a notice, alarm, failure to complete a transaction, etc. The tampered indicator may include a message component and/or synchronization component that are unreadable until heated and returned to room temperature. This approach may also allow tracking how often cards are subjected to heat attacks. The digital watermark ID or message component may be static (e.g., printed as part of the label or package design), related to a batch lot, or fully serialized to enable better tracking of compromised cards. The digital watermark may be printed or applied on labels close to areas requiring heat protection in the form of binary dots, reducing the amount and cost of ink required while preventing card activation if tampered with.
3. Black-to-White Irreversible Ink: This type of thermochromic ink is black at a base temperature and turns opaque white when heated, without returning to black when cooled. Such ink can serve as a background color for digital watermarks printed in light colors, such as white. When not tampered with, the black-to-white irreversible ink provides sufficient contrast for the digital watermark to be read by a digital watermark detector. When exposed to heat, the black-to-white irreversible in changes from black to white, causing the digital watermark to become unreadable as the light ink loses contrast against the now-white background. Black-to-white irreversible thermochromic ink can be applied to a scratch-off label protecting a PIN, CVV or other information area, to neighboring areas printed directly on the substrate to which a label is applied, or both. In one implementation, a digital watermark in white ink may cover a scratch-off label including holographic film and areas printed with black-to-white ink. The same digital watermark can be also printed over areas covered by black or black-to-white ink directly printed on the substrate to which the scratch-off label is applied. If the label is heated, the ink on the label or surrounding areas will change color.
4. Strategic Spatial Arrangement: When combining black-to-white ink with other materials, such as holographic foil, the components can be spatially arranged to prevent fraudsters from selectively applying heat to limited areas while keeping remaining areas cool. One effective arrangement is shown in FIG. 22 and involves an area covered by a label with holographic foil (area 0), surrounded by areas covered with the same scratch-off label containing black-to-white ink (areas 2 and 4), with additional areas (1 and 3) that may also be covered by black-to-white or regular black ink. In this configuration, the digital watermark secures all areas (0-4) together while protecting against complete label repositioning. The digital watermark signal serves as both an authentication mechanism and a tamper indicator in this configuration. When scanned with an image scanner (e.g., barcode scanner), a digital watermark reader analyzing captured imager, can decode the digital watermark to confirm authenticity. However, if heat has been applied to a portion of the label to access hidden information (e.g., PIN, CVV, etc.), a resulting color change in the thermochromic ink areas will disrupt the digital watermark's frame of reference, causing digital watermark authentication to fail. This provides immediate evidence of tampering without requiring visual inspection of the security feature. This configuration is particularly effective because it combines multiple security technologies-holographic foil, thermochromic ink, and digital watermarking—in a spatially interdependent arrangement that prevents selective tampering. The design protects against both complete label repositioning and localized tampering attempts, providing comprehensive security for value documents such as lottery tickets, gift cards, and identification documents, among other types.
5. Semi-Reversible Thermochromic Inks: Some thermochromic inks may be semi-reversible, such as black-to-clear inks that are black at a base temperature, turn transparent when heated, remain transparent when returned to the base temperature, but revert to black when cooled below a certain temperature (e.g., below 10° C.-20° C.). These semi-reversible inks can be used similarly to the black-to-white irreversible inks described in FIG. 22. For example, areas 2 and 4 may first be printed with a digital watermark indicating package tampering, then overlaid with black-to-clear ink applied on a clear label. When not tampered with by heat, only the digital watermark carrying activation information is visible. When tampered with, the black ink becomes clear, revealing an additional digital watermark that indicates tampering and/or that the value document should not be authenticated or activated (e.g., in the case of a gift card, credit card, debit card, etc.).
6. Ink Mixtures: Thermochromic inks can be mixed with existing inks and printed using industrial inkjet heads. This allows conventional white ink to be transformed into white-to-black (or gray) ink when heated, causing an activation digital watermark to lose contrast and become unreadable. A similar effect can be achieved with clear ink and red-to-clear dye, creating a mixed ink that transitions from red to clear when heated.
7. Production Process Integration: Semi-irreversible thermochromic inks can be printed, thermally activated during the card production process (e.g., during card heat sealing), and then deactivated by applying freezing air (spot cooling), such as from Vortex tubes that can achieve temperatures as low as, e.g., −46° C.
8. Thermochromic Topcoat: Thermochromic inks can serve as a topcoat layer in scratch-off labels. When printed over holographic foil, the topcoat layer thermochromic ink initially appears clear. Upon heating, it irreversibly shifts or changes to white or gray, becoming semi-opaque or opaque. This change significantly reduces contrast with the white digital watermark ink, effectively preventing it from being read or detected by a digital watermark reader. Colors could also be selected to appear white under red light, such as yellow and red.

### Sandwich Label Approach

A sandwich label approach provides enhanced security against heat-based tampering. In this implementation, a bottom label with a fragile opaque topcoat is applied first, the PIN, CVV or activation information is printed over it, and a scratch-off top label is applied as a finish. If the top label is scratched off as intended, the PIN or other information is revealed. However, if a fraudster attempts to peel off the top label, it removes the bottom layer's topcoat along with the PIN or other information from the bottom label. The opacity of the bottom label's fragile topcoat ensures that the PIN or other information adhering to the top label is not readable by the fraudster.

### Scratch Tamper Sensitivity

Traditional scratch-off surfaces can be vulnerable to fine scratching using needle-like tools that partially reveal PINs or other hidden information. This vulnerability can be mitigated by mixing flakes of scratch-resistant material into the scratch-off coating. The presence or absence of these flakes creates an irregular surface that resists precise, controlled scratching. The size of the flakes can be varied, as large flakes may prevent the label from bending properly or may detach from the surface.

### Copy Attack Countermeasures

To counter copy attacks where fraudsters photograph value documents using mobile phones with flash in dark rooms, then adjust for perspective distortion and print with standard printers, several countermeasures can be implemented:
1. Energy-Shifting Ink: Using an ink that shifts energy from approximately 450 nm to approximately 660 nm when exposed to flash photography. This ink would jam or interfere with a digital watermark signal, making copy and successful printing more difficult.
2. Enhanced Holographic Foil Designs: Improved holographic foil designs can make copying more challenging: i. Alternative cracked ice designs with smaller or more irregular shapes; and ii. Instead of standard rainbow effects, using alternative color-shifting options where color shapes turn bright under red light to reduce contrast with white ink. This would interfere with the digital watermark signal during copying and re-printing.

By incorporating heat-resistant and copy-resistant security features into value documents, the integrity of hidden information can be better protected against sophisticated tampering attempts. One solution is to use irreversible thermochromic inks, for example, inks that change color from clear to black when exposed to heat and never go back to clear. Background value document colors or background behind machine-readable codes (e.g., barcodes or digital watermarks) are examples of where such inks can be used. Localized application of heat does not trigger the heat sensitive label area but allows for penetration of the package. Heat thus presents an industry-wide threat to transaction card solutions, not limited to the above embodiments.

Thermochromic inks: thermochromic inks present options as discussed above, with some manufacturers including, e.g.: Matsui International Inc. of Gardena CA, and Atlanta Chemical Engineering, LLC. Clear to bright ink (e.g., under illumination at a wavelength of 660 nm) can be introduced over the scratch-off label (potentially over a holographic foil pattern). An ink color change introduces a contrast change resulting in loss of digital watermark elements reflective contrast for successful reading. Black to clear thermochromic ink, such as IRREVERSIBLE THERMOCHROMIC LIQUID INK from Atlantic Chemical Engineering, can be used in some embodiments on a value document card to provide contrast for a digital watermark overprinted in white ink. When exposed to heat, contrast of the digital watermark elements is lost, and the card may no longer be activated.

### III. Operating Environments

The components and operations of the various described embodiments and implementations shown in figures and/or discussed in text above, can be implemented in modules. Notwithstanding any specific discussion of the embodiments set forth herein, the term “module” may refer to software, firmware and/or circuitry configured to perform any of the methods, processes, algorithms, functions or operations described herein. Software may be embodied as a software package, code, instructions, instruction sets, or data recorded on non-transitory computer readable storage mediums. Software instructions for implementing the detailed functionality can be authored by artisans without undue experimentation from the descriptions provided herein, e.g., written in C, C++, Objective-C, and C#, Ruby, MatLab, Visual Basic, Java, Python, Tcl, Perl, Scheme, and assembled in executable binary files, etc., in conjunction with associated data. Firmware may be embodied as code, instructions or instruction sets or data that are hard-coded (e.g., nonvolatile) in memory devices. As used herein, the term “circuitry” may include, for example, singly or in any combination, hardwired circuitry, programmable circuitry such as one or more computer processors comprising one or more individual instruction processing cores, parallel processors, multi-core processors, state machine circuitry, or firmware that stores instructions executed by programmable circuitry.

Applicant's work also includes taking the scientific principles and natural laws on which the present technology rests and tying them down in particularly defined implementations. One such realization of such implementations is electronic circuitry that has been custom-designed and manufactured to perform some or all of the component acts, as an application specific integrated circuit (ASIC).

To realize such implementations, some or all of the technology is first implemented using a general-purpose computer, using software such as MatLab (from MathWorks, Inc.). A tool such as HDLCoder (also available from MathWorks) is next employed to convert the MatLab model to VHDL (an IEEE standard, and doubtless the most common hardware design language). The VHDL output is then applied to a hardware synthesis program, such as Design Compiler by Synopsis, HDL Designer by Mentor Graphics (now Siemens EDA), or Encounter RTL Compiler by Cadence Design Systems. The hardware synthesis program provides output data specifying a particular array of electronic logic gates that will realize the technology in hardware form, as a special-purpose machine dedicated to such purpose. This output data is then provided to a semiconductor fabrication contractor, which uses it to produce the customized silicon part. (Suitable contractors include TSMC, Global Foundries, and ON Semiconductors.)

The methods, processes, components, technology, apparatus and systems described above may be implemented in hardware, software or a combination of hardware and software. For example, the digital watermark embedding and optimizations may be implemented in software, firmware, hardware, combinations of software, firmware and hardware, a programmable computer, electronic processing circuitry, digital signal processors (DSP), FPGAS, graphic processing units (GPUs), a programmable computer, electronic processing circuitry, and/or by executing software or instructions with a one or more processors including parallel processors, one or more multi-core processor(s) and/or other multi-processor configurations.

### CONCLUDING REMARKS

Having described and illustrated the principles of the technology with reference to specific implementations, it will be recognized that the technology can be implemented in many other, different, forms. To provide a comprehensive disclosure without unduly lengthening the specification, applicant hereby incorporates by reference each of the above-mentioned patent documents in its entirety.

The particular combinations of elements and features in the above-detailed embodiments are exemplary only; the interchanging and substitution of these teachings with other teachings in this and the incorporated-by-reference patent documents are also contemplated.

1-134. (canceled)

135. A method for creating a tamper-evident feature for product authentication, the method comprising:
generating a payload comprising encoded product information;
applying robustness encoding to the payload to produce a set of encoded message components;
mapping the encoded message components to locations on different product parts, comprising at least mapping a first subset of encoded message components to a first product component and mapping a second subset of encoded message components to a second product component different from said first product component;
adapting robustness of the encoded message components differently across the different product parts by selectively modifying robustness characteristics of the encoded message components based on respective locations, wherein adapting robustness comprises varying levels of robustness encoding applied to each subset of encoded message components;
assessing robustness tolerances of the encoded message components by determining message detection scores; and
iteratively adjusting the robustness of the encoded message components until optimal tolerances are achieved.

136. The method of claim 135 wherein successful reading of the encoded product information requires contemporaneous scanning of all encoded message components in their original applied positions, such that any tampering involving separation, removal, or repositioning of any product component bearing encoded message components renders the encoded product information unreadable.

137. The method of claim 135 wherein the robustness encoding comprises at least one of error correction encoding, spread spectrum modulation, and repetition coding.

138. The method of claim 135, wherein the encoded message components comprise a digital watermark imperceptibly embedded within visual elements of the different product parts while remaining machine-readable when scanned.

139. The method of claim 135, wherein adapting robustness of the encoded message components comprises:
sub-dividing error correction encoded bits into portions;
identifying locations of spread spectrum modulated bits corresponding to each portion residing in different product parts; and
selectively modifying modulated bits to yield modified bits to decrease robustness by introducing entropy in a manner that makes the modified bits appear as noise to a signal decoder.

140. The method of claim 135, wherein adapting robustness of the encoded message components comprises:
creating two versions of an error correction encoded signature, a first version with no modification to payload bits and a second version with randomly modified selected bits of the payload;
comparing the two versions to identify bits within the error correction encoded signature that change because of the modification, thereby identifying relevant bits;
identifying locations of message components corresponding to the relevant bits on the different product parts; and
adapting robustness of the message components of the relevant bits differently across the different product parts.

141. The method of claim 140, further comprising:
dilating ink modifications that encode the relevant bits to increase likelihood of accurate message recovery from different viewing angles; and
minimizing collisions where dilation of nearby relevant bit encodings would conflict with each other.

142. The method of claim 135, wherein the encoded message components comprise:
complementary error correction data such that each subset comprises error correction information for at least one other subset, creating an interdependent security system where modification of any single subset corrupts error correction functionality of the encoded product information.

143-195. (canceled)

196. A tamper-evident product comprising:
a first product component and a second product component different from said first product component;
a payload comprising encoded product information; and
encoded message components produced by applying robustness encoding to the payload,
wherein the encoded message components are mapped to locations on the first product component and the second product component, comprising at least a first subset of encoded message components mapped to the first product component and a second subset of encoded message components mapped to the second product component; wherein robustness of the encoded message components is adapted differently across the first product component and the second product component by selectively modifying robustness characteristics of the encoded message components based on respective locations, and
wherein successful reading of the encoded product information requires contemporaneous scanning of all encoded message components in their original applied positions, such that any tampering involving separation, removal, or repositioning of any product component bearing encoded message components renders the encoded product information unreadable.

197. The tamper-evident product of claim 196, wherein the robustness encoding comprises at least one of error correction encoding, spread spectrum modulation, and repetition coding.

198. The tamper-evident product of claim 196, wherein the encoded message components comprise a digital watermark imperceptibly embedded within visual elements of the first product component and the second product component while remaining machine-readable when scanned.

199. The tamper-evident product of claim 196, wherein the encoded message components comprise:
error correction encoded bits sub-divided into portions;
spread spectrum modulated bits located at identified locations corresponding to each portion residing in different product parts; and
modified bits yielding decreased robustness by introducing entropy in a manner that makes the modified bits appear as noise to a signal decoder.

200. The tamper-evident product of claim 196, comprising:
two versions of an error correction encoded signature, a first version with no modification to payload bits and a second version with randomly modified selected bits of the payload;
relevant bits identified by comparing the two versions to identify bits within the error correction encoded signature that change because of the modification;
message components corresponding to the relevant bits located on the first product component and the second product component; and
wherein robustness of the message components of the relevant bits is adapted differently across the first product component and the second product component.

201. The tamper-evident product of claim 200, further comprising:
dilated ink modifications that encode the relevant bits to increase likelihood of accurate message recovery from different viewing angles; and
minimized collisions where dilation of nearby relevant bit encodings are configured to avoid conflict with each other.

202. The tamper-evident product of claim 196, wherein the encoded message components comprise complementary error correction data such that each subset comprises error correction information for at least one other subset, creating an interdependent security system where modification of any single subset corrupts error correction functionality of the encoded product information.

203. A method for authenticating a product having tamper-evident features, the product comprising a first product component and a second product component different from the first product component, the method comprising:
scanning encoded message components from the first product component and the second product component, wherein a first subset of encoded message components is mapped to the first product component and a second subset of encoded message components is mapped to the second product component;
contemporaneously reading the encoded message components in their original applied positions;
applying error correction decoding to the encoded message components to reconstruct encoded product information from robustness encoding that was applied to a payload comprising the encoded product information;
determining message detection scores to assess robustness tolerances of the encoded message components; and
generating an authentication result based on successful reading of the encoded product information, wherein any tampering involving separation, removal, or repositioning of any product component bearing encoded message components renders the encoded product information unreadable.

204. The method for authenticating the product of claim 203, wherein the encoded message components comprise complementary error correction data such that each subset comprises error correction information for at least one other subset, and wherein the method further comprises reconstructing the encoded product information, wherein modification of any single subset corrupts error correction functionality of the encoded product information.

205. The method for authenticating the product of claim 203, wherein the encoded message components comprise a digital watermark imperceptibly embedded within visual elements of the first product component and the second product component, and wherein scanning comprises machine-reading the digital watermark, in which the digital watermark is generally imperceptible to human observation.

206. The method for authenticating the product of claim 203, wherein the robustness encoding comprises at least one of error correction encoding, spread spectrum modulation, and repetition coding, and wherein said scanning comprises identifying locations of spread spectrum modulated bits corresponding to each subset of encoded message components residing in different product parts and detecting modified bits that yield decreased robustness by introducing entropy in a manner that makes the modified bits appear as noise to a signal decoder.

207. A non-transitory computer readable medium comprising instructions stored therein that, when executed by a computer system, cause said computer system to perform the method of claim 206.
